(19) United States
(12) Patent Application Publication
(10) Pub. No.: US 2012/0320423 A1
(43) Pub. Date: Dec. 20, 2012

(54) PRINTING APPARATUS PROVIDED WITH PLURAL PROCESSING SYSTEMS FOR GENERATING PRINT DATA, PRINTING METHOD AND RECORDING MEDIUM

(75) Inventor: Masaki KOBAYASHI, Tokyo (JP)

(73) Assignee: CASIO COMPUTER CO., LTD., Tokyo (JP)

(21) Appl. No.: 13/526,356

(22) Filed: Jun. 18, 2012

(30) Foreign Application Priority Data
Jun. 20, 2011 (JP) 2011-136543

(51) Int. Cl. G06K 15/00

(52) U.S. Cl. 358/1.16

(57) ABSTRACT

A printing apparatus has a first memory of a high data access speed and a second memory of a low data access speed, the first memory having a small memory capacity and the second memory having a large memory capacity. The printing apparatus has a receiver for receiving print data in parallel from plural host apparatuses, a judging unit for judging whether the first memory is in use, and a storing-process controller for storing the print data in the first memory, when the judging unit determines that the first memory is not in use, and for storing the print data in the second memory, when the judging unit determines that the first memory is in use. The printing apparatus prints the print data of a high priority order on a print medium with use of the first memory.

### CROSS-REFERENCE TO RELATED APPLICATIONS

The present application is based upon and claims the benefit of priority from the prior Japanese Patent Application No. 2011-136543, filed Jun. 20, 2011, the entire contents of which are incorporated herein by reference.

### BACKGROUND OF THE INVENTION

1. Field of the Invention

The present invention relates to a printing apparatus, to which plural host apparatuses are connected via a network.

2. Description of the Related Art

Today, printing systems are used, in which host apparatuses such as host computers and a printing apparatus such as a printer and a so-called combined machine are connected to each other through a network. In the printing systems, the printing apparatus receives print data from plural host apparatuses connected thereto through the network and prints the received data.

In the printing apparatus, for example, an interface controller (hereinafter, “I/F controller”) receives the print data (PDL (Page Description Language)) from the host apparatuses and converts the received data, for example, into raster image data of a format, which can be transferred to an printer engine.

To convert the print data into the raster image data, a Raster Image Processor (RIP) is used. This converting process generates the raster image data and outputs pixel data in real time, but the converting process applies much load to CPU installed in the printing apparatus and consumes almost all of the power of CPU.

Therefore, in the printing apparatus, which is able to simultaneously receive the print data from plural host apparatuses, CPU falls in lack of power, and can not meet performance of a printer engine.

To solve the above disadvantage, the printing apparatus executes RIP process on only one of the plural pieces of received print data, and with respect to the remaining pieces of received print data, the printing apparatus just holds them in a data-receiving buffer within said printing apparatus.

In order to execute the data receiving process and RIP process effectively, the I/F controller of the printing apparatus performs the data-receiving process and the RIP process out of synchronization, and exchanges the print data between the two processes with use of the data-receiving buffer.

Japanese Patent No. Hei11-331530 A discloses a system, in which peripheral apparatuses including a printing apparatus for printing images, a scanning apparatus for reading images, and a facsimile apparatus for transferring/receiving data, are connected to each other through the network, and RAM is used in the case where a high speed access is required and a large storing capacity is not needed so much and a hard disk drive is used in the case where a large storing capacity is required and a high speed access is not needed so much, and data is exchanged among the above peripheral apparatuses.

However, in the case where RAM is used as the data-receiving buffer, RAM is better in a data access speed but has a disadvantage that is not enough in a memory capacity to hold the print data.

Meanwhile, in the case where the hard disk drive is used as the data-receiving buffer, hard disk drive is enough in the data storing capacity to hold the print data but has a disadvantage that is not better in the data access speed.

### SUMMARY OF THE INVENTION

According to one aspect of the invention, there is provided a printing apparatus for printing on a print medium print data received from plural host apparatuses, the printing apparatus, which comprises a first memory unit which stores the print data received from one of the plural host apparatuses, a second memory unit of a data access speed lower than the first memory unit, which stores the print data received from another one of the plural host apparatuses when the first memory unit is in use for storing the print data received previously, a receiving unit which receives the print data in parallel from the plural host apparatuses, a judging unit which judges whether the first memory unit is in use, and a storing-process controlling unit which starts a first storing process for storing first received print data in the first memory unit, when the judging unit determines that the first memory unit is not in use, and which starts a second storing process for storing second received print data in the second memory unit, when the first storing process is in process and the judging unit determines that the first memory unit is in use.

According to another aspect of the invention, therein provided a printing apparatus for printing on a print medium print data received from plural host apparatuses, the printing apparatus which comprises a first memory unit which stores the print data received from one of the plural host apparatuses, a second memory unit of a data access speed lower than the first memory unit, which stores the print data received from another one of the plural host apparatuses when the first memory unit is in use for storing the print data received previously, a receiving unit which receives the print data in parallel from the plural host apparatuses, a judging unit which judges whether the first memory unit is in use, a storing-process controlling unit which starts a first storing process for storing first received print data in the first memory unit, when the judging unit determines that the first memory unit is not in use, and which starts a second storing process for storing second received print data in the second memory unit, when the first storing process is in process and the judging unit determines that the first memory unit is in use, and a memory changing unit which changes a memory area for storing print data from the second memory unit to the first memory unit, when the judging unit has determined that the first memory unit is freed while the print data is being stored in the second memory unit.

According to still another aspect of the invention, there is provided a printing apparatus for printing on a print medium print data received from plural host apparatuses, the printing apparatus, which comprises a first memory unit which stores the print data received from one of the plural host apparatuses, a second memory unit of a data access speed lower than the first memory unit, which stores the print data received from another one of the plural host apparatuses when the first memory unit is in use for storing the print data received previously, a receiving unit which receives the print data in parallel from the plural host apparatuses, a judging unit which judges whether the first memory unit is in use, a storing-process controlling unit which starts a first storing process for storing first received print data in the first memory unit, when the judging unit determines that the first memory unit is not in use, and which starts a second storing process for storing second received print data in the second memory unit, when the first storing process is in process and the judging unit determines that the first memory unit is in use, a processing order determining unit which determines a processing order of the received print data, a memory determining unit which determines a memory area for storing print data, based on the decision made by the judging unit of whether the first memory unit is in use and the decision made by the processing order determining unit, and a memory changing unit which changes a memory area for storing print data from the second memory unit to the first memory unit, when the memory determining unit has determined to change the memory while the print data is being stored in the second memory unit, and which changes the memory area from the first memory unit to the second memory unit, when the memory determining unit has determined to change the memory while the print data is being stored in the first memory unit.

### BRIEF DESCRIPTION OF THE DRAWINGS

FIG. 1 is a view illustrating a system configuration of a printing apparatus according to the first embodiment of the invention.

FIG. 2 is a view for explaining the printing apparatus which simultaneously receives print data output from plural host computers.

FIG. 3 is a view for explaining a configuration of data contained in a state table used in the first embodiment of the invention.

FIG. 4 is a view showing the configuration of data contained in the state table for explaining a printing operation in the first embodiment of the invention.

FIG. 5 is a flow chart of a processing operation performed by a receiving unit in the first embodiment of the invention.

FIG. 6 is a flow chart of a processing operation performed by a controlling unit in the first embodiment of the invention.

FIG. 7 is a flow chart of a processing operation performed by a RIP unit in the first embodiment of the invention.

FIG. 8 is a view illustrating the system configuration of the printing apparatus according to the second embodiment of the invention.

FIG. 9 is a view for explaining a configuration of data contained in the state table used in the second embodiment of the invention.

FIG. 10 is a view showing the configuration of data contained in the state table for explaining a printing operation in the second embodiment of the invention.

FIG. 11 is a flow chart of a processing operation performed by the receiving unit in the second embodiment of the invention.

FIGS. 12 and 13 are flow charts of a processing operation performed by the controlling unit in the second embodiment of the invention.

FIG. 14 is a flow chart of a processing operation performed by the RIP unit in the second embodiment of the invention.

FIG. 15 is a view showing the configuration of data set in the state table after notice of switching a buffer has been given in the second embodiment of the invention.

FIG. 16 is a view illustrating the system configuration of the printing apparatus according to the third embodiment of the invention.

FIG. 17 is a view showing a configuration of data contained in the state table used in the third embodiment of the invention.

FIG. 18 is a view showing the configuration of data in the state table for explaining the printing operation in the third embodiment of the invention.

FIG. 19 is a flow chart of a processing operation performed by the receiving unit in the third embodiment of the invention.

FIGS. 20 to 22 are flow charts of a processing operation performed by the controlling unit in the third embodiment of the invention.

FIG. 23 is a flow chart of a processing operation performed by the RIP unit in the third embodiment of the invention.

FIG. 24 is a view showing the configuration of data set in the state table after an interruption process is performed in the third embodiment of the invention.

### DETAILED DESCRIPTION OF THE PREFERRED EMBODIMENTS

Now, embodiments of the present invention will be described in detail with reference to the accompanying drawings.

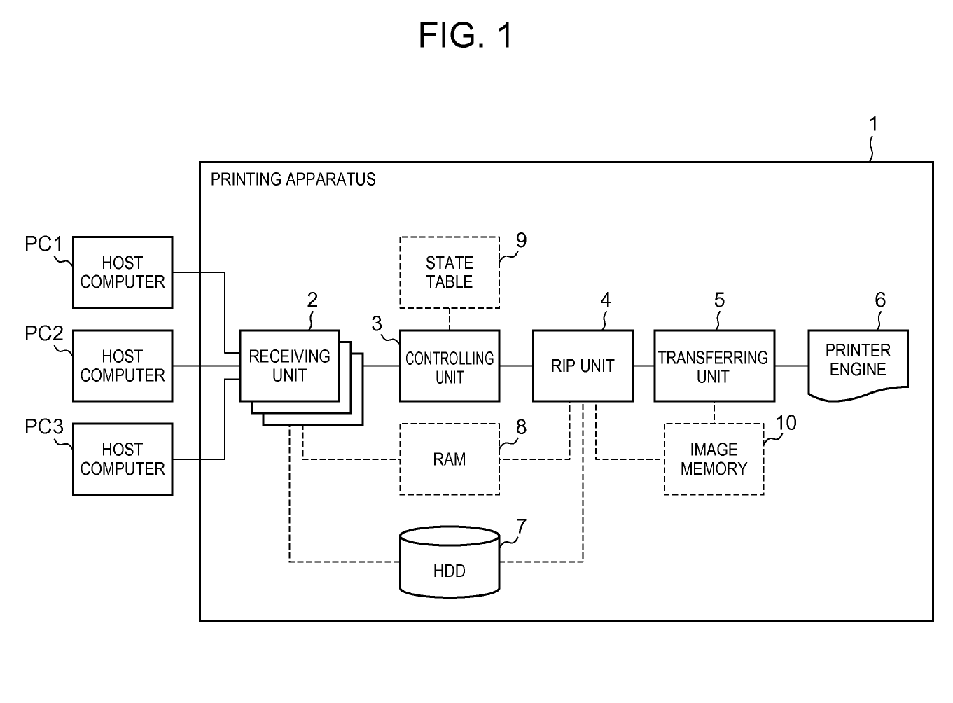

FIG. 1 is a view illustrating a system configuration of a printing apparatus according to the first embodiment of the invention. As shown in FIG. 1, for example, the printing apparatus 1 is connected to three host computers PC1 to PC3 via a network such as LAN. The printing apparatus 1 comprises a receiving unit 2, a controlling unit 3, RIP (Raster Image Processor) unit 4, a transferring unit 5, a printer engine 6, a hard disk drive (HDD) 7, RAM 8, a state table 9 and an image memory 10.

The host computers PC1 to PC3 convert print data generated in accordance with application software into print data (PDL data) with use of a printer driver and sends the print data (PDL data) to the printing apparatus 1. When the receiving unit 2 receives the print data sent from the host computers PC1 to PC3, the printing apparatus 1 sends a receiving-start signal to the controlling unit 3. The receiving unit 2 is capable of simultaneously receiving the print data sent from plural host computers PC1 to PC3.

The receiving unit 2 receives the print data sent from the host computers PC1 to PC3 and sends the received print data to the hard disk drive 7 or RAM 8. RAM 8 has a memory area for storing the print data, for example, of several pages, and stores the print data input through the receiving unit 2. The hard disk drive 7 has a storage area for storing plural pieces of print data, and stores the print data input through the receiving unit 2.

Upon receipt of the receiving-start signal from the receiving unit 2, the controlling unit 3 gives the receiving unit 2 a response of a receiving-start allowance and searches through all the records registered in the state table 9, performing various controlling operations to be described later.

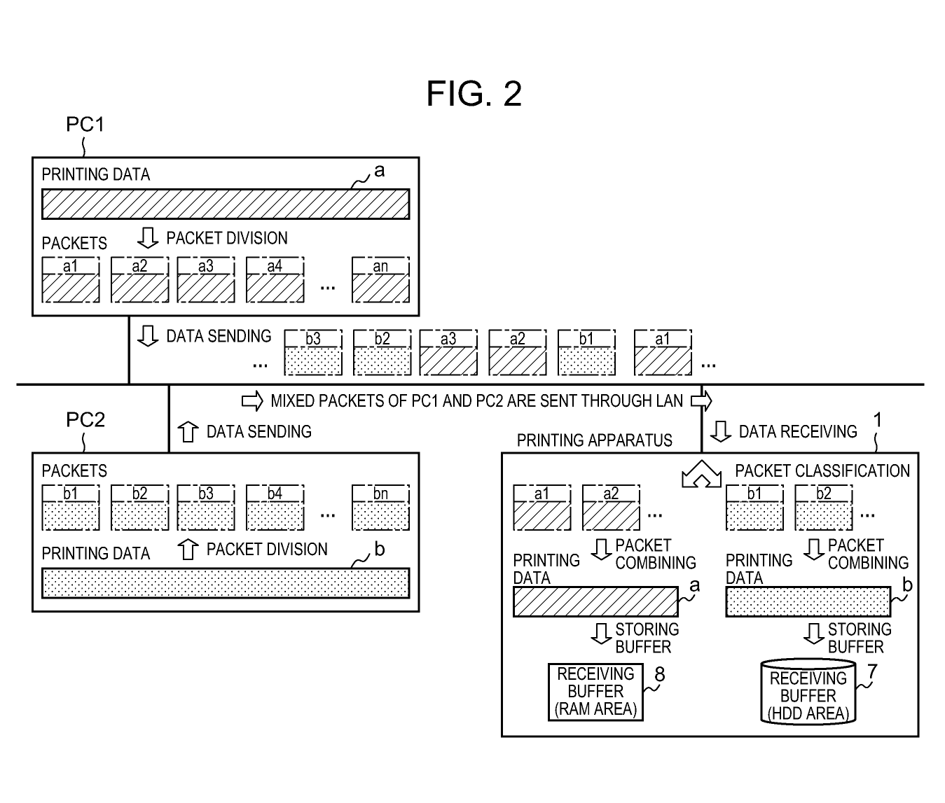

As described above, the printing apparatus 1 according to the embodiment of the invention is capable of simultaneously receiving the print data from plural host computers, and one example of the printing apparatus 1 will be described hereinafter. FIG. 2 is a view for explaining the printing apparatus 1 which simultaneously receives the print data output from the host computers PC1 and PC2.

The host computer PC1 generates print data “a” in accordance with the application software, and divides the print data “a” into plural packets “a1” to “an” and then sends these packets “a1” to “an” to the printing apparatus 1 via the network (LAN). In addition to content data, the packets “a1” to “an” contain information of an originating host computer, and information of a packet sequence, which are required at packet combining. In the same manner, the host computer PC2 generates print data “b” in accordance with the application software, and divides the print data “b” into plural packets “b1” to “bn” and then sends these packets “b1” to “bn” to the printing apparatus 1 via the network (LAN).

The receiving unit 2 receives the mixed packets “a1” to “an” and “b1” to “bn” (print data), which are sent via the network (LAN) and combines the received packets in accordance with the information of the originating host computers and the information of the packet sequence, reproducing original print data “a” and “b”. The print data “a” and “b” received at the same time as described above are sent to the hard disk drive 7 or RAM 8 to be stored therein.

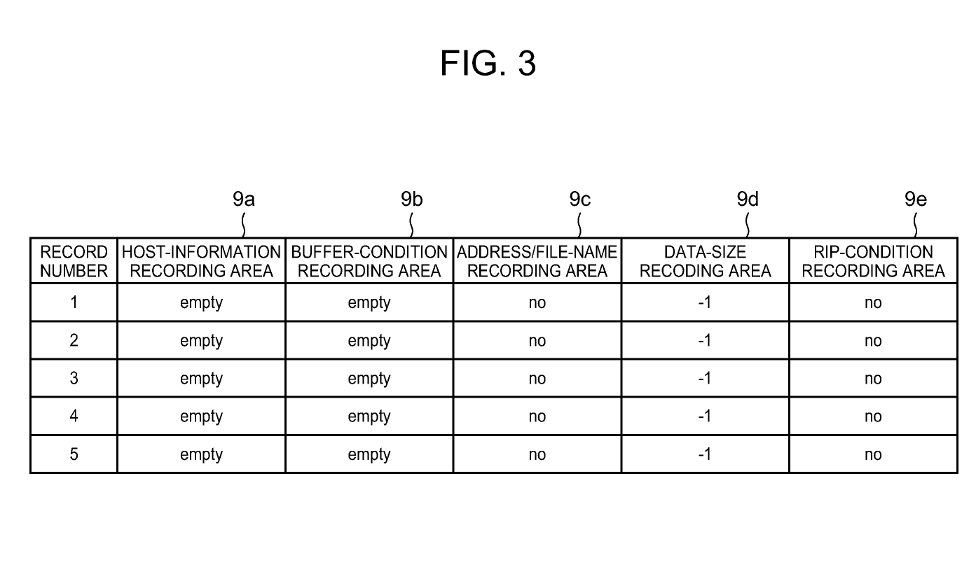

FIG. 3 is a view for explaining a configuration of data contained in the state table 9. The state table 9 stores information of the print data output from the host computers PC1 to PC3. The state table 9 is provided with a host-information recording area 9a, a buffer-condition recording area 9b, an address/file-name recording area 9c, a data-size recording area 9d, and a RIP-condition recording area 9e, in which various sorts of information corresponding respectively to record numbers are recorded.

For instance, the host-information recording area 9a records information of the host computers PC1 to PC3, which have sent the print data, and the buffer-condition recording area 9b records information of the hard disk drive 7 or RAM 8, which stores the print data. Further, the address/file-name recording area 9c records addresses or file names of the print data, and the data-size recording area 9d records data sizes of the print data. The RIP condition recording area 9e records driving conditions of the RIP unit 4. For instance, while the RIP unit 4 is in operation, information representing “RIP in operation” is recorded in the RIP-condition recording area 9e, and while the RIP unit 4 is out of operation, information representing “no” is recorded in the RIP-condition recording area 9e.

In the state table 9 at the initial time, all records in the host-information recording area 9a are reset to a condition of “empty”, and all records in the buffer-condition recording area 9b are reset to a condition of “empty”. Further, all records in the address/file-name recording area 9c are reset to a condition of “no”, all records in the data-size recording area 9d are reset to “−1” and all records in the RIP-condition recording area 9e are reset to a condition of “no”.

Upon receipt of the receiving-start signal from the receiving unit 2, the controlling unit 3 sequentially searches through the records in the state table 9 from the record number 1, and stores the host information in the host-information recording area 9a of the first record, which is now in the condition of “empty”.

In accordance with an instruction from the controlling unit 3, the RIP unit 4 reads the print data from the hard disk drive 7 or RAM 8, and analyzes a command to convert the print data into drawing data. The drawing data converted by the RIP unit 4 is expanded on the image memory 10.

When a predetermined amount of drawing data is expanded, the transferring unit 5 reads the drawing data from the image memory 10 and transfers the data to the printer engine 6. The printer engine 6 performs a printing process on recording medium (for example, a printing paper) based on the transferred print data.

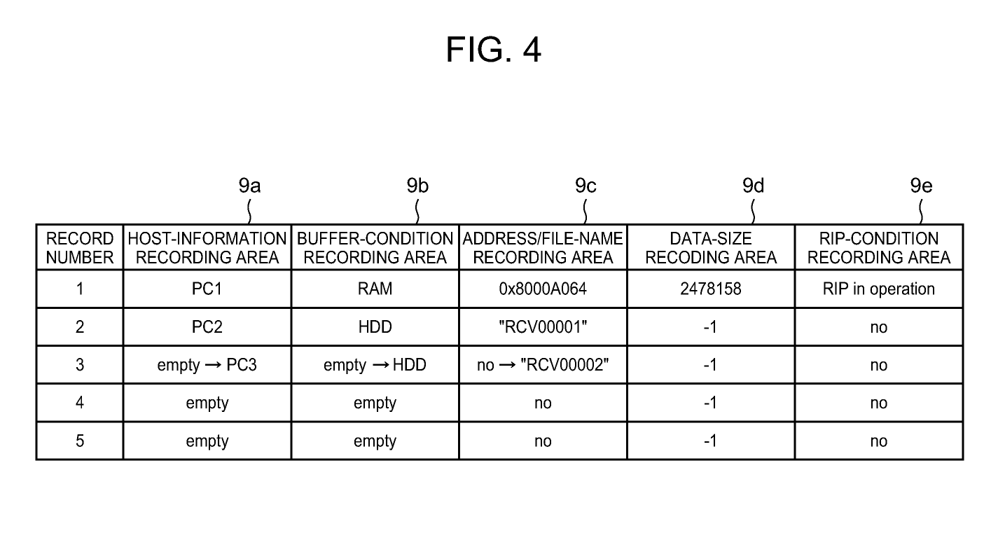

A processing operation to be performed by the printing apparatus 1 having the configuration described above will be described hereinafter. Before describing the processing operation by the printing apparatus 1, it is assumed that information shown in FIG. 4 is already recorded in the state table 9. For instance, in the host-information recording area 9a of the record number 1 is recorded information of “PC1”, which represents that the print data has been sent from the host computer PC1, and in the buffer-condition recording area 9b of the record number 1 is recorded information of “RAM”, which represents that the print data is stored in RAM 8. In the address/file-name recording area 9c of the record number 1 is recorded information of “0x8000A064”, which represents that the address where print data is stored is “0x8000A064”, and in the data-size recording area 9d of the record number 1 is recorded information of “2478158”, which represents that the print data has a data size of “2478158”.

As described above, the information of the print data sent from the host computer PC1 is recorded in the state table 9 of the record number 1, and for example, since the print data is stored in RAM 8 and information of “RIP in operation” is recorded in the RIP-condition recording area 9e of the record number 1, it is represented that the RIP unit 4 is in operation and analyzes the print data stored in RAM 8.

In a similar manner, in the host-information recording area 9a of the record number 2 is recorded information of “PC2”, which represents that the print data is sent from the host computer PC2, and in the buffer-condition recording area 9b of the record number 2 is recorded information of “HDD”, which represents that the print data is stored in the hard disk drive 7. In the address/file-name recording area 9c of the record number 2 is stored information of “RCV00001”, which represents that a file name of print data is “RCV00001”, and in the data-size recording area 9d of the record number 2 is recorded information of “−1”, which represents that information of a data size has not been set. As described above, the information recorded in the state table 9 of the record number 2 represents that the print data having the file name of “RCV00001” is sent from the host computer PC2 and is being subjected to a storing process into the hard disk drive 7.

At the time when the process starts, the description will be made hereinafter on the assumption that the remaining records in the state table 9 are set to the initial conditions, respectively.

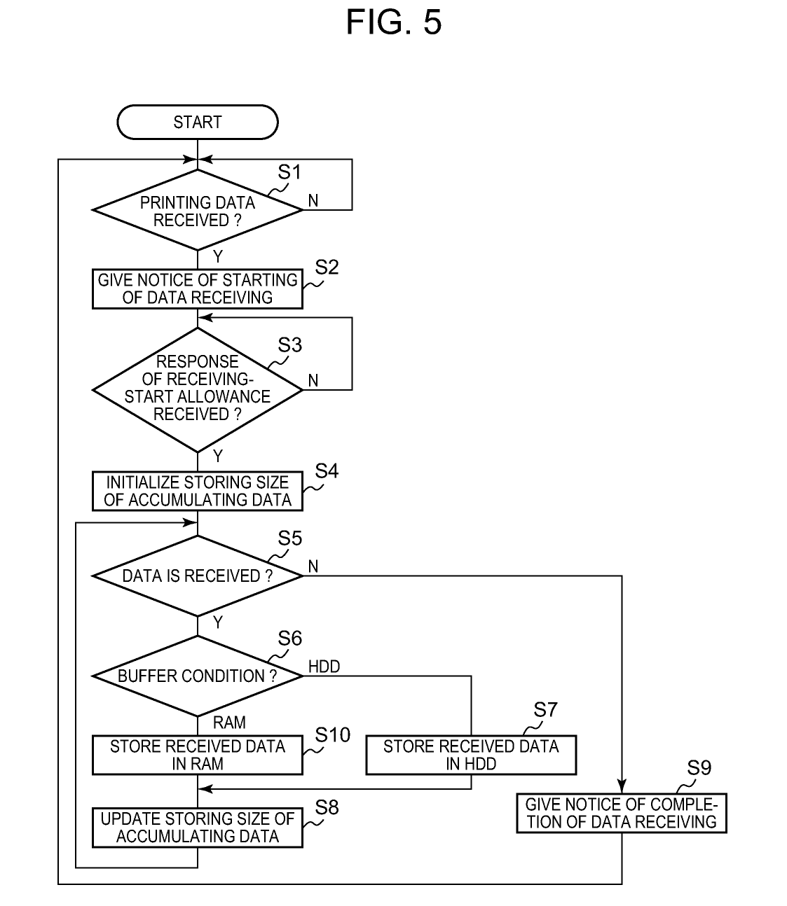

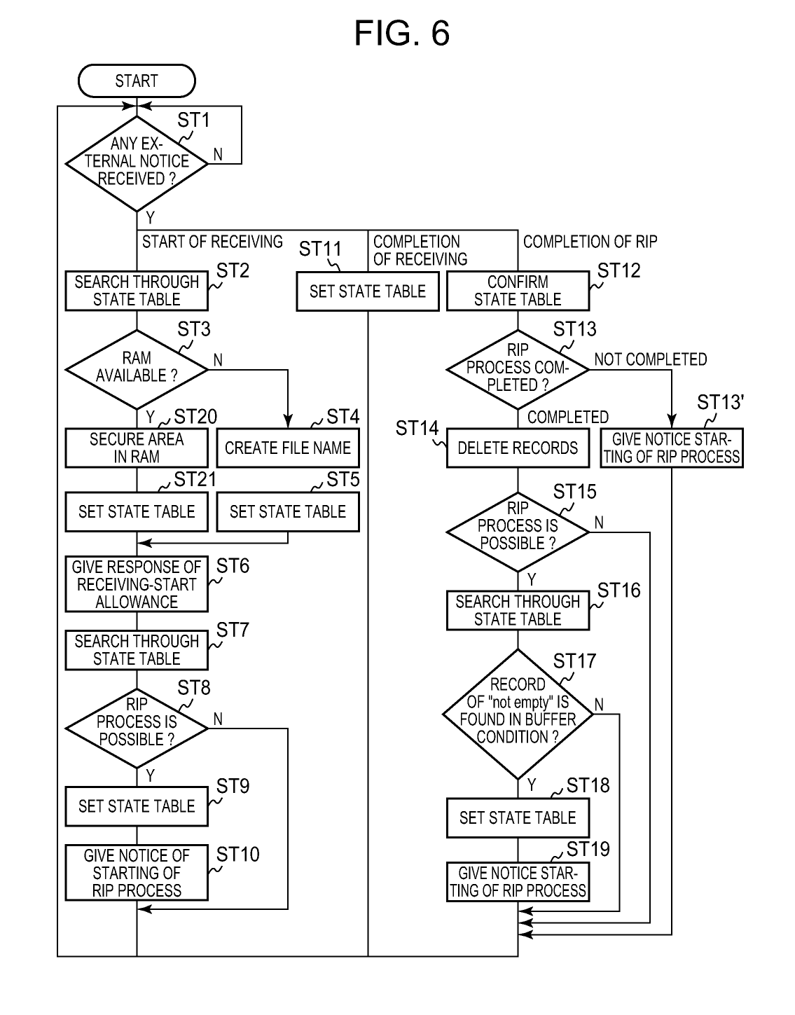

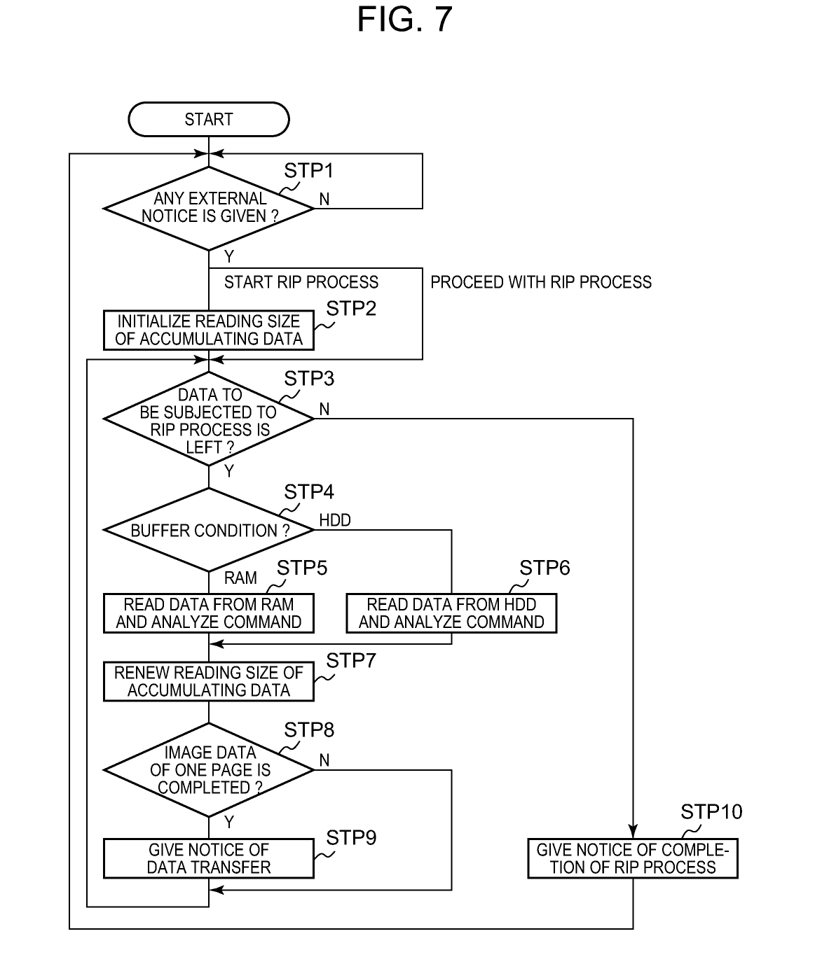

FIG. 5 is a flow chart of a processing operation performed by the receiving unit 2 in the first embodiment of the invention. FIG. 6 is a flow chart of a processing operation performed by the controlling unit 3 in the present embodiment of the invention. FIG. 7 is a flow chart of a processing operation performed by the RIP unit 4 in the present embodiment of the invention.

The receiving unit 2 judges at step S1 in the flow chart of FIG. 5, whether the print data has been received from the host computers PC1 to PC3 through the network. While no print data is received (NO at step S1), the receiving unit 2 repeatedly judges whether the print data has been received (step S1). When the print data has been received from the host computers PC1 to PC3 (YES at step S1), the receiving unit 2 gives the controlling unit 3 notice of starting of print data receiving (step S2). In other words, the receiving unit 2 sends the receiving-start signal to the controlling unit 3, and waits for a response of a receiving-start allowance from the controlling unit 3 (step S3).

Hereinafter, the following description will be made on the assumption that the print data has been already input to the receiving unit 2 from the host computers PC1 and PC2 and new print data will be input to the receiving unit 2 from the host computer PC3, as indicated by the state table 9 shown in FIG. 4.

Upon receipt of the receiving-start signal from the receiving unit 2, the controlling unit 3 starts a processing in accordance with the flow chart shown in FIG. 6. The controlling unit 3 judges whether any external notice has been received (step ST1). In this case, the controlling unit 3 has received the receiving-start signal from the receiving unit 2 (YES at step ST1) and searches through the records in the state table 9 (step ST2) to judges whether RAM 3 is available (step ST3). This judgment is made by referring to a record registered in the buffer-condition recording area 9b of the state table 9 shown in FIG. 4.

In the state table 9 shown in FIG. 4, the information of “RAM” is recorded in the buffer-condition recording area 9b of the record number 1 and the print data sent from the host computer PC1 has been already stored in RAM 8.

Therefore, RAM 8 is in use at present (NO at step ST3), and the controlling unit 3 creates a new file name of the print data stored in the hard disk drive 7 (step ST4), and sets the file name in the corresponding area of the state table 9 (step ST5). For instance, in the state table shown in FIG. 4, in the host-information recording area 9a of the record number 3 is recorded information of “PC3”, which represents that the print data has been sent from the host computer PC3, and in the buffer-condition recording area 9b of the record number 3 is recorded information of “HDD”, and in the address/file-name recording area 9c of the record number 3 is recorded information of a file name “RCV00002”.

Thereafter, the controlling unit 3 gives the receiving unit 2 a response of a receiving-start allowance (step ST6). Upon receipt of the response of a receiving-start allowance from the controlling unit 3 (YES at step S3 in FIG. 5), the receiving unit 2 initializes a storing size of accumulating data (step S4).

Then, the receiving unit 2 judges whether data has been received (step S5). When it is determined that the print data has been received (YES at step S5), the receiving unit 2 judges a buffer condition (step S6) to execute a writing process of the print data. In the case of the state table 9 shown in FIG. 4, since the information of “HDD” is already recorded in the buffer-condition recording area 9b of the record number 3 (HDD at step S6), new print data sent from the host computer PC3 is stored in a new area of the hard disk drive 7 (step S7) and the storing size of the accumulating data in the hard disk drive 7 is updated (step S8).

While receiving the print data (YES at step S5), the receiving unit 2 successively stores the received print data in the hard disk drive 7 (steps S5 to S8). When having finished receiving the print data (NO at step S5), the receiving unit 2 gives the controlling unit 3 notice of completion of print data receiving (step S9).

Upon receipt of the notice of completion of print data receiving (YES at step ST1 in FIG. 6), the controlling unit 3 sets the state table 9 (step ST11) to register data representing the above storing size of accumulating data in the data-size recording area 9d of the record number 3.

After giving the receiving unit 2 the response of a receiving-start allowance (step ST6), the controlling unit 3 searches through the records in the state table 9 (step ST7) to judge whether it is possible for the RIP unit 4 to execute a RIP process (step ST8). The judgment is made by referring to a record registered in the RIP-condition recording area 9e of the state table 9 shown in FIG. 4. Since the information of “RIP in operation” is stored in the RIP-condition recording area 9e of the record number 1 in the state table 9, a further RIP process is not executed on the print data (NO at step ST8).

In other words, at this time, the RIP unit 4 is executing the RIP process on the print data in accordance with the records registered in the state table 9 of the record number 1, and judges whether any external notice has been given (step STP1 in the flow chart of FIG. 7) to start the RIP process. In the case of the state table 9 shown in FIG. 4, the controlling unit 3 has already given the RIP unit 4 an instruction of starting the RIP process to be executed on the print data in accordance with the records registered in the record number 1, and the RIP unit 4 executes the RIP process on the print data, initializing a reading size of accumulating data (step STP2).

More specifically, the RIP unit 4 judges whether there is left any data to be read or any data which has not yet been subjected to the RIP process (step STP3). When there is left in RAM 8 the print data registered in the record number 1 (YES at step STP3), the RIP unit 4 judges the buffer condition (step STP4), and reads the print data from RAM 8, executing a command analyzing process of the print data (step STP5).

The RIP unit 4 renews the reading size of accumulating data (step STP7). For instance, the RIP unit 4 judges whether image data of one page has been completed (step STP8), and when the image data of one page has not been completed (NO at step STP8), the RIP unit 4 repeatedly executes the above processes (steps STP3 to SIPS, and steps STP7 to STP9).

During these processes, the image data is successively expanded on the image memory 10 and when the image data of one page has been completed (YES at step STP8), the RIP unit 4 gives the transferring unit 5 notice of data transfer (step STP9). Thereafter, the RIP unit 4 judges whether there is left in RAM 8 the print data to be processed (step STP3). When it is determined that no print data is left in RAM 8 (NO at step STP3), the RIP unit 4 gives the controlling unit 3 notice of completion of the RIP process (step STP10).

Upon receipt of the notice of completion of the RIP process from the RIP unit 4 (YES at step ST1 in FIG. 6), the controlling unit 3 confirms the records in the state table 9 (step ST12) to judge whether the RIP process has been completed (step ST13). When it is determined that the RIP process has been completed (completed at step ST13), the controlling unit 3 executes a deleting process of corresponding record information (step ST14). For instance, the controlling unit 3 deletes information of the record 1 from the state table 9 shown in FIG. 4. In other words, information recorded in the host-information recording area 9a of the record number 1 and information recorded in the buffer-condition recording area 9b of the record number 1 are deleted from the state table 9.

In consideration of new print data input to RAM 8, when the RIP process has not been completed on the data in RAM 8 (not completed at step ST13), the controlling unit 3 gives the RIP unit 4 notice of proceeding with the RIP process (step ST13′).

After performing the deleting process at step ST14, the controlling unit 3 judges whether the RIP process is possible for the RIP unit 4 to execute (step ST15). When it is determined that the RIP process is possible for the RIP unit 4 to execute (YES at step ST15), the controlling unit 3 searches through the records in the state table 9 (step ST16) to judge whether any record of “not empty” is found in the buffer condition (step ST17). When a record of “not empty” is found in the buffer condition (YES at step ST17), for instance, when information of “HDD” is registered in the buffer-condition recording area 9b of the record number 2 as shown in FIG. 4 (YES at step ST17), the controlling unit 3 sets the state table 9 (step ST18) and gives the RIP unit 4 notice of starting of the RIP process (step ST19). In other words, the controlling unit 3 stores the information of “RIP in operation” in the RIP-condition recording area 9e of the record number 2 (step ST18), and gives the RIP unit 4 notice of starting of the RIP process (step ST19).

In this case, the RIP unit 4 reads the print data of the file name “RCV00001” from the hard disk drive 7, which is registered in the buffer-condition recording area 9b of the record number 2 in the state table 9 of FIG. 4, and analyzes the command. In other words, the RIP unit 4 confirms the buffer condition (step STP4 in FIG. 7) and designates the hard disk drive 7 (HDD at step STP4) to read the print data from the hard disk drive 7, and then analyzes the command of the print data (step STP6).

Meanwhile, when it is determined that the RIP process is not possible for the RIP unit 4 to execute (NO at step ST15 in FIG. 6), or when all the buffer conditions are empty (NO at ST17), the controlling unit 3 executes no further RIP process and waits for an external notice (step ST1).

As described above, in the case where the print data is already stored in RAM 8, new input print data will be stored in the hard disk drive 7. Even if RAM 8 should be brought empty while the print data is being stored in the hard disk drive 7, the print data is kept being stored in the hard disk drive 7.

In the case that RAM 8 is kept empty and the information of “RAM” is not registered in the buffer-condition recording area 9b, upon receipt of the receiving-start signal from the receiving unit 2 (YES at step ST1 in FIG. 6), the controlling unit 3 searches through the records in the state table 9 (step ST2). When it is determined that RAM 8 is available (YES at step ST3), the controlling unit 2 secures an area in RAM 8 (step ST20) and sets the state table 9 (step ST21). In this case, the controlling unit 2 records the information of “RAM” in the buffer-condition recording area 9b of the corresponding record number in the state table 9 and gives the receiving unit 2 a response of a receiving-start allowance (step ST6). Thereafter, upon receipt of the response of a receiving-start allowance from the controlling unit 3 (YES at step S3 in FIG. 5), the receiving unit 2 stores the received data in RAM 8 (RAM at step S6, step S10). In this case, once the receiving unit 2 has started storing the print data in RAM 8, the receiving unit 2 keeps storing the print data in RAM 8.

In the present embodiment of the invention, in the case that RAM 8 is not empty, new print data is stored in the hard disk drive 7, and in the case that RAM 8 is empty, new print data is stored in RAM 8. While receiving the print data, the receiving unit 2 does not change the medium for storing the print data from the hard disk drive 7 to RAM 8 and vice versa. Therefore, even if plural pieces of print data are input to the receiving unit 2, a load to be applied on CPU is reduced and the printing process is effectively performed.

Now, the second embodiment of the invention will be described.

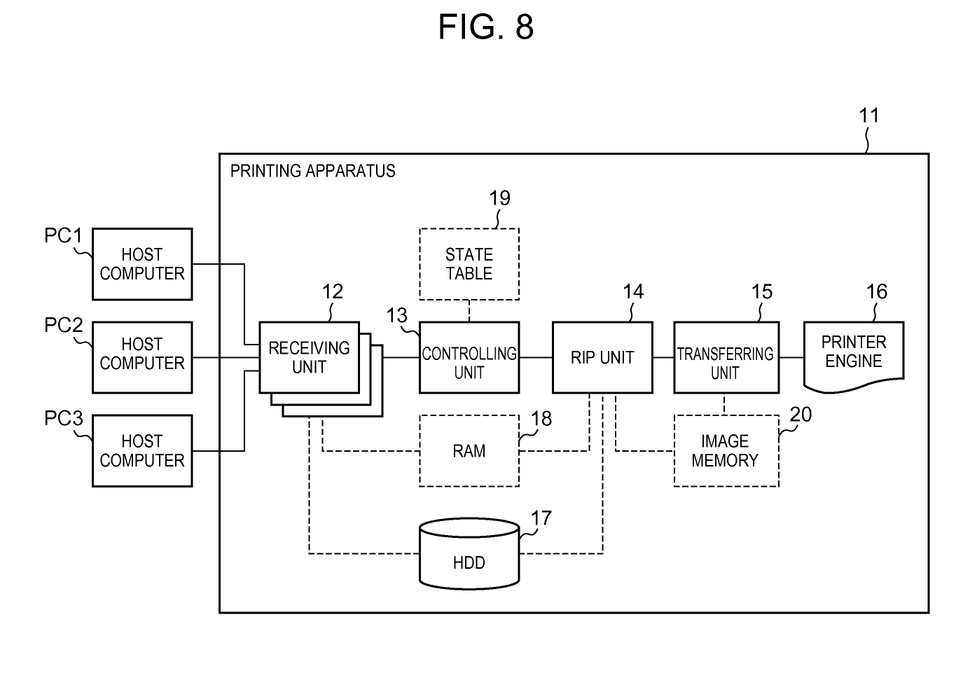

FIG. 8 is a view illustrating the system configuration of the printing apparatus according to the second embodiment of the invention. The printing apparatus 11 according to the second embodiment of the invention has substantially the same fundamental configuration as the first embodiment of the invention. The printing apparatus 11 is connected with three host computers PC1 to PC3 via the network such as LAN. The printing apparatus 11 comprises a receiving unit 12, a controlling unit 13, RIP unit 14, a transferring unit 15, a printer engine 16, a hard disk drive 17, RAM 18, a state table 19 and an image memory 20.

With use of a printer driver the host computers PC1 to PC3 convert data produced in accordance with application software into print data (PDL data) and sends the print data (PDL data) to the printing apparatus 11. When the receiving unit 2 receives the print data sent from the host computers PC1 to PC3, the printing apparatus 11 sends the receiving-start signal to the controlling unit 13. The receiving unit 12 receives the print data sent from the host computers PC1 to PC3 and sends the received data to the hard disk drive 17 or RAM 18. The receiving unit 12 is capable of simultaneously receiving the print data sent from plural host computers. In other words, the receiving unit 12 is capable of simultaneously receiving two pieces of print data “a” and “b”, as shown in FIG. 2.

Upon receipt of the receiving-start signal from the receiving unit 12, the controlling unit 13 gives the receiving unit 12 a response of a receiving-start allowance and searches through all the records in the state table 19, performing various controlling operations to be described later.

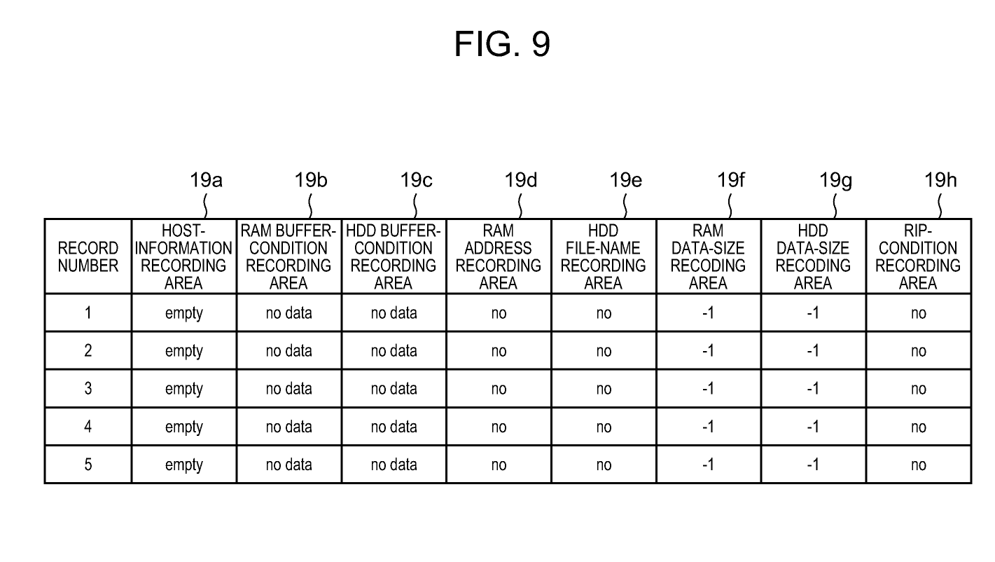

FIG. 9 is a view for explaining a configuration of data contained in a state table 19 used in the second embodiment of the invention. Different from the state table 9, the state table used in the second embodiment of the invention has a host-information recording area 19a, a RAM buffer-condition recording area 19b, a HDD buffer-condition recording area 19c, a RAM address recording area 19d, a HDD file-name recording area 19e, a RAM data-size recording area 19f, a HDD data-size recording area 19g, and a RIP condition recording area 19h, and stores various sorts of information in areas corresponding to the record numbers, respectively.

For instance, the host-information recording area 19a stores information of the host computers PC1 to PC3, which have sent the print data, the RAM buffer-condition recording area 19b records information representing that the print data is stored in RAM 18, and the HDD buffer-condition recording area 19c records information representing that the print data is stored in the hard disk drive 17. Further, the RAM address recording area 19d records information of addresses where the print data is stored in RAM 18.

The HDD file-name recording area 19e records file names of the print data stored in the hard disk drive 17, the RAM data-size recording area 19f records data sizes of the files stored in RAM 18, the HDD data-size recording area 19g records data sizes of the files stored in the hard disk drive 17, and the RIP condition recording area 19h records driving conditions of the RIP unit 14. For instance, while the RIP unit 14 is in operation, information representing “RAM in RIP operation” and/or “HDD in RIP operation” are recorded in the RIP condition recording area 19h.

In the state table 19 of the initial condition as shown in FIG. 9, all the records in the host-information recording area 19a are reset to “empty”, all the records in the RAM buffer-condition recording area 19b are reset to “no data”, all the records in the HDD buffer-condition recording area 19c are reset to “no data”, all the records in the RAM address recording area 19d are reset to “no”, all the records in the HDD file-name recording area 19e are reset to “no”, all the records in the RAM data-size recording area 19f are reset to “−1”, all the records in the HDD data-size recording area 19g are reset to “−1”, and all the records in the RIP condition recording area 19h are reset to “no”.

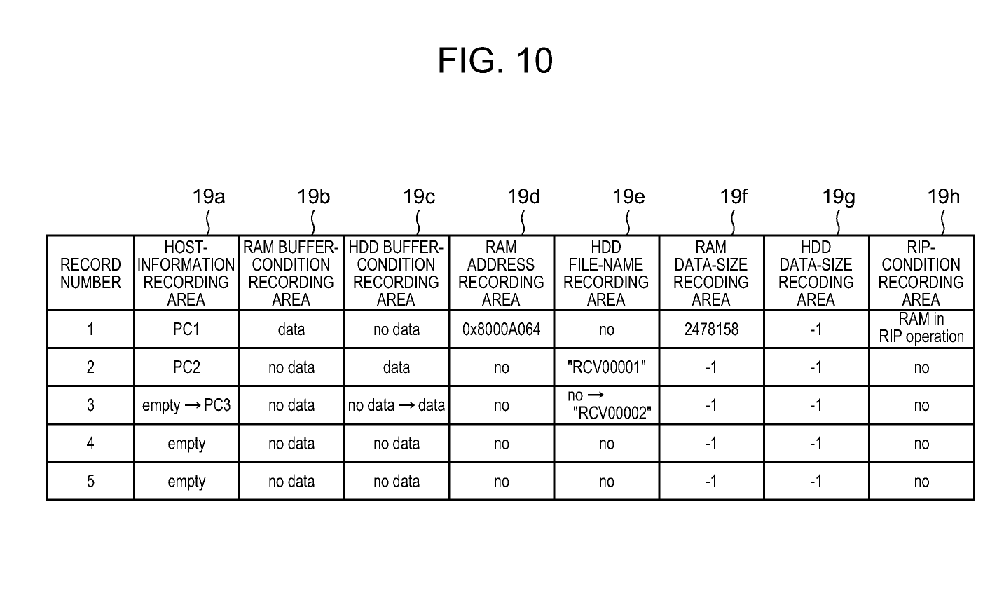

The processing operation of the printing apparatus 11 having the configuration described above will be described hereinafter. Before describing the processing operation by the printing apparatus 11, it is assumed that information shown in FIG. 10 is already recorded in the state table 19. For instance, in the host-information recording area 19a of the record number 1 is recorded information of “PC1”, which represents that the print data has been sent from the host computer PC1, and in the RAM buffer-condition recording area 19b of the record number 1 is recorded information of “data”, which represents that the print data is stored in RAM 8. In the RAM address recording area 19d of the record number 1 is recorded information of “0x8000A064”, which represents that the address where the print data is stored is “0x8000A064”, and in the RAM data-size recording area 19f of the record number 1 is recorded information of “2478158”, which represents that the print data has a data size of “2478158”.

As described above, the information of the print data sent from the host computer PC1 is recorded in the state table 19 of the record number 1, and the information of “RAM in RIP operation” is recorded in the RIP condition recording area 19h of the record number 1, which represents that the RIP unit 14 is in operation and analyzing the print data stored in RAM 18.

In a similar manner, in the host-information recording area 19a of the record number 2 is recorded the information of “PC2”, which represents that the print data has been sent from the host computer PC2, and in the HDD buffer-condition recording area 19c of the record number 2 is recorded information of “data”, which represents that the print data is stored in the hard disk drive 17. In the HDD file-name recording area 19e of the record number 2 is recorded the information of “RCV00001”, which represents that the file name of print data is “RCV00001”.

At the time when the process starts in the second embodiment of the invention, it is assumed that the remaining records in the state table 19 are set to the initial conditions, respectively.

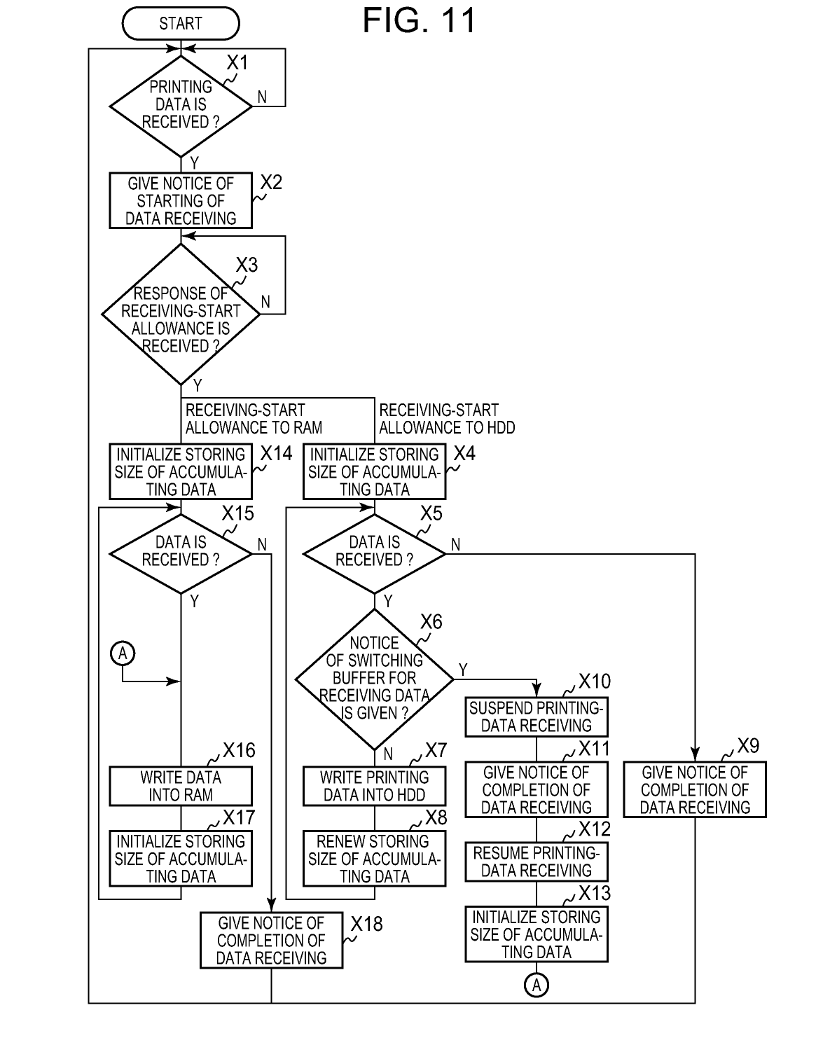

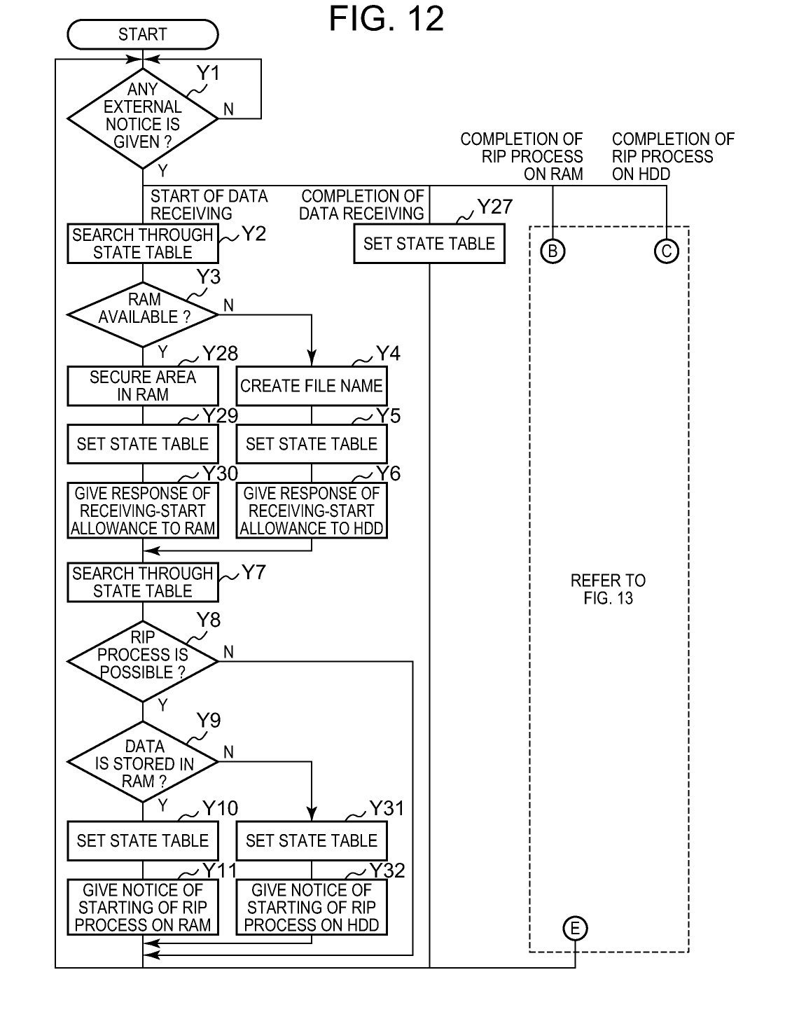

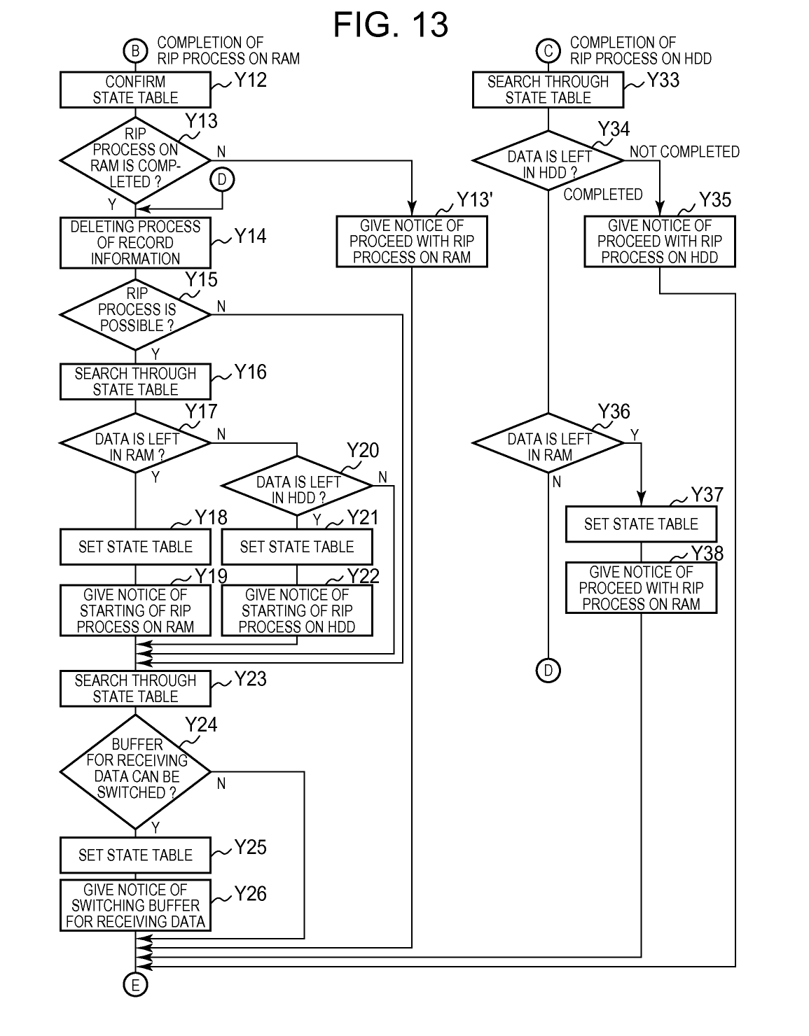

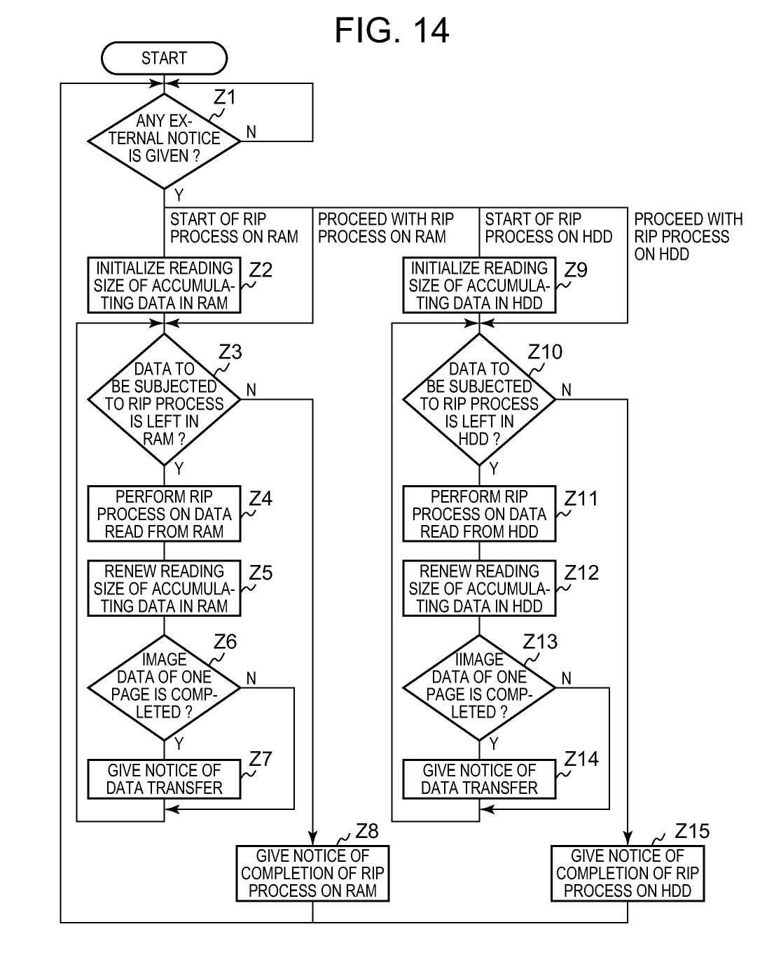

FIG. 11 is a flow chart of a processing operation performed by the receiving unit 12 in the second embodiment of the invention. FIGS. 12 and 13 are flow charts of a processing operation performed by the controlling unit 13 in the second embodiment of the invention. FIG. 14 is a flow chart of a processing operation performed by the RIP unit 14 in the second embodiment of the invention.

The receiving unit 12 judges whether the print data has been received from any of the host computers PC1 to PC3 connected to the network (step X1 in the flow chart of FIG. 11). While no print data is received (NO at step X1), the receiving unit 12 repeatedly judges whether the print data has been received (step X1). When the print data has been received from either of the host computers PC1 to PC3 (YES at step X1), the receiving unit 12 gives the controlling unit 13 notice of starting of print data receiving (step X2), and waits for a response of a receiving-start allowance from the controlling unit 13 (step X3).

Hereinafter, the second embodiment of the invention will be described on the assumption that the print data has been already input to the receiving unit 12 from the host computers PC1 and PC2 and new print data will be input to the receiving unit 12 from the host computer PC3, as indicated in the state table 19 shown in FIG. 10.

Upon receipt of the receiving-start signal from the receiving unit 12, the controlling unit 13 judges whether any external notice has been received (step Y1 in the flow chart shown in FIG. 12). In this case, the controlling unit 13 has received the receiving-start signal from the receiving unit 12 (YES at step Y1), and searches through the records in the state table 19 (step Y2) to judges whether RAM 13 is available (step Y3). In the same manner as described above, this judgment is made by referring to the record recorded in the RAM buffer-condition recording area 19b of the state table 19 shown in FIG. 10.

In the state table 19 shown in FIG. 10, the information of “data” is registered in the RAM buffer-condition recording area 19b of the record number 1 and the print data sent from the host computer PC1 has been already stored in RAM 18.

Therefore, RAM 18 is in use at present and it is determined NO at step Y3. Then, a HDD file-name is created (step Y4) and the file name is set to the corresponding area in the state table 19 (step Y5). For instance, in the state table 19 shown in FIG. 10, in the host-information recording area 19a of the record number 3 is recorded the information of “PC3”, which represents that the print data has been sent from the host computer PC3, in the HDD buffer-condition recording area 19c of the record number 3 is recorded the information of “data”, which represents that the print data is stored in the hard disk drive 17, and in the HDD file-name recording area 19e of the record number 3 is recorded the information of the file name “RCV00002”. Then, the controlling unit 13 gives the receiving unit 12 a response of a receiving-start allowance to the hard disk drive 17 (step Y6).

Upon receipt of the response of a receiving-start allowance from the controlling unit 13 (YES at step X3 in FIG. 11), the receiving unit 12 judges whether the response of a receiving-start allowance is to RAM 18 or to the hard disk drive 17. Since the response of a receiving-start allowance is to the hard disk drive 17, the receiving unit 12 initializes the storing size of data accumulating in the hard disk drive 17 (step X4).

The receiving unit 12 judges whether any data has been received (step X5). When it is determined that data (print data) has been received (YES at step X5), the receiving unit 12 judges whether notice of switching the buffer for receiving data has been given (step X6). For example, notice of switching the buffer for receiving data is given at the time when RAM 18 is brought empty while the print data is being stored in the hard disk drive 17.

When notice of switching the buffer for receiving data is not given (NO at step X6), the receiving unit 12 writes the print data into the hard disk drive 17 (step X7) and renews the storing size of accumulating data in the hard disk drive 17 (step X8). Thereafter, the receiving unit 12 repeatedly performs the above processes (steps X5, X6, X7 and X8) to write the print data into the hard disk drive 17. When no more print data is input to be written into the hard disk drive 17 (NO at step X5), the receiving unit 12 gives the controlling unit 13 notice of completion of print data receiving (step X9). The above processes are performed while notice of switching the buffer for receiving data is not given.

Meanwhile, the controlling unit 13 performs the following controlling operation at the same time and therefore RAM 18 can be brought empty. In other words, giving a response of a receiving-start allowance to the receiving unit 12 (step Y6 in FIG. 12), the controlling unit 13 searches through the records in the state table 19 (step Y7) to judge whether it is possible for the RIP unit 14 to execute the RIP process (step Y8). This judgment is made by referring to the record recorded in the RIP condition recording area 19h of the state table 19 shown in FIG. 10. In the state table shown in FIG. 10, the information of “RAM in RIP operation” is registered in the RIP condition recording area 19h of the record number 1 (NO at step Y8) and the RIP unit 14 executes the RIP process on the print data memorized in RAM 18.

Even if the information of “RAM in RIP operation” is not registered in the RIP condition recording area 19h of the record number 1 (YES at step Y8), data is stored in RAM 18 (YES at step Y9). The controlling unit 13 records the information of “RAM in RIP operation” in the RIP condition recording area 19h in the state table 19 (step Y10) and gives the RIP unit 14 notice of starting of the RIP process to be performed on the print data memorized in RAM 18 (step Y11). Meanwhile, even if the print data is not stored in RAM 18 (NO at step Y9), the controlling unit 13 records the information of “HDD in RIP operation” in the RIP condition recording area 19h (step Y31) when the print data is stored in the hard disk drive 17, and gives the RIP unit 14 notice of starting of the RIP process to be performed on the print data in the hard disk drive 17 (step Y32).

The RIP unit 14 judges whether any external notice has been given and starts the RIP process (step Z1 in the flow chart shown in FIG. 14). The RIP unit 14 performs the RIP process on the print data stored in RAM 18, and initializes the reading size of the accumulated data in RAM 18 (step Z2), and then judges if there is left data to be subjected to the RIP process (step Z3).

In this case, since the print data whose record is registered in the record number 1 is left in RAM 18 (YES at step Z3), the RIP unit 14 reads the print data from RAM 18 to execute the RIP process thereon (step Z4). The RIP unit 14 renews the reading size of the accumulating data (step Z5), and judges whether image data of one page has been completed (step Z6). When it is determined that the image data of one page has not yet been completed (NO at step Z6), the RIP unit 14 repeatedly performs the above processes (steps Z3 to Z6).

When the image data is successively expanded on the image memory 20 and the image data of one page has been completed (YES at step Z6), the RIP unit 14 gives the transferring unit 15 notice of data transfer (step Z7). Thereafter, the RIP unit 14 judges if there is left the print data in RAM 18 (step Z3). When it is determined that no print data is left in RAM 18 (NO at step Z3), the RIP unit 14 gives the controlling unit 13 notice of completion of the RIP process on the data in RAM 18 (step Z8).

Meanwhile, when the print data stored in RAM 18 is read therefrom and an empty area is born in RAM 18, it is possible for the receiving unit 12 to store the print data of the hard disk drive 17 in such empty area of RAM 18.

Upon receipt of the notice of completion of the RIP process performed on data in RAM 18 from the RIP unit 14, the controlling unit 13 performs a process “B” shown in FIG. 12 (more specifically, the process “B” shown in FIG. 13). More specifically, the controlling unit 13 confirms the records registered the state table 19 (step Y12 in FIG. 13) to judge whether the RIP process is executed on the data in RAM 18 (step Y13). When it is determined that the RIP process has completed on the data in RAM 18 (YES at step Y13), the controlling unit 13 deletes the information recorded in the record number 1 from the state table 19 (step Y14). In consideration of the print data left in RAM 8, when the RIP process has not been completed on data in RAM 8 (not completed at step Y13), the controlling unit 13 gives the RIP unit 14 notice of proceeding with the RIP process (step Y13′).

After deleting the information corresponding to the record number 1 (step Y14), the controlling unit 13 judges whether the RIP process is possible for the RIP unit 14 to execute (step Y15). When it is determined that the RIP process is possible for the RIP unit 14 to execute (YES at step Y15), the controlling unit 13 searches through the records in the state table 19 (step Y16). When it is determined that data is left in RAM 18 (YES at step Y17), the controlling unit 13 sets the state table 19 accordingly (step Y18) and gives the RIP unit 14 notice of starting of the RIP process on the print data stored in RAM 18 (step Y19).

Meanwhile, when it is determined that no data is found in RAM 18 (NO at step Y17), the controlling unit 13 judges whether data is left in the hard disk drive 17 (step Y20). When it is determined that data is found in the hard disk drive 17 (YES at step Y20), the controlling unit 13 sets the state table 19 accordingly (step Y21). In the case of the state table 19 shown in FIG. 10, the record number 2 is set to indicate that data is stored in the hard disk drive 17. Then, the controlling unit 13 gives the RIP unit 14 notice of starting of the RIP process to be executed on the print data in the hard disk drive 17 (step Y22).

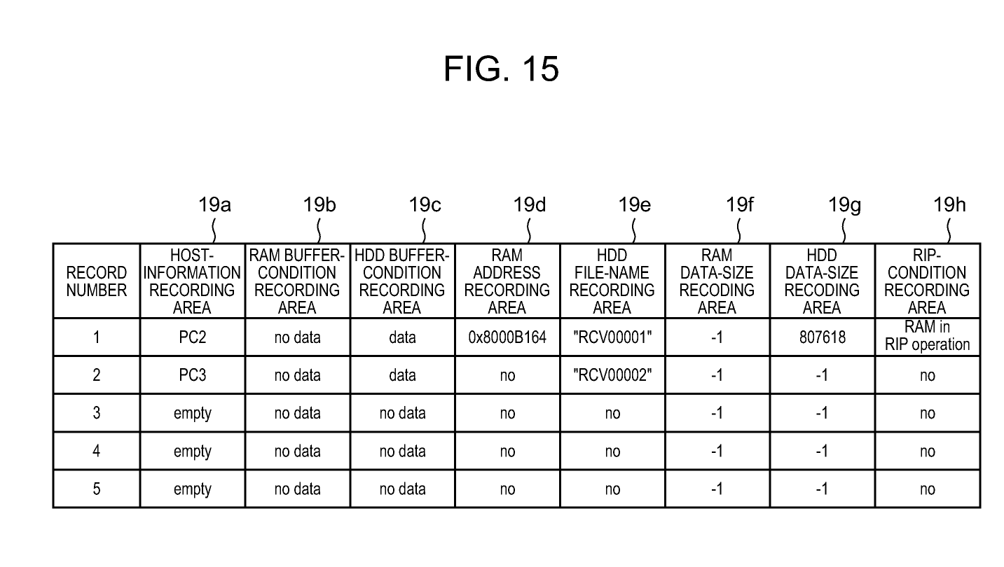

Further, the controlling unit 13 searches through the records in the state table 19 (step Y23) to judge whether it is possible to switch the buffer for receiving data (step Y24). In this case, since the print data has been already read from RAM 18, it is possible to switch the buffer for receiving data (YES at step Y24). Accordingly, the table setting process is performed on the state table 19 (step Y25) to set from that shown in FIG. 10 to that shown in FIG. 15. More specifically, the information of the record number 2 is moved up to be recorded in the areas of the record number 1, the information recorded in which has been already subjected to the printing process. Further, the information of the record number 3 is moved up to be recorded in the areas of the record number 2. Accordingly, in the areas of the record number 1 is recorded information of the print data, which is sent from the host computer PC2 and has the file name “RCV00001” registered in the hard disk drive 17. In the areas of the record number 2 is recorded information of the print data of the file name “RCV00002”, which data is sent from the host computer PC3 and stored in the hard disk drive 17. Further, the controlling unit 13 gives the receiving unit 12 notice of switching the buffer for receiving data (step Y26). In other words, since RAM 18 has been brought empty, the print data can be stored in RAM 18, and the controlling unit 13 gives the receiving unit 12 notice of switching the buffer for receiving data.

Upon receipt of the notice of switching the buffer for receiving data, the receiving unit 12 determines that it has received the notice of switching the buffer for receiving data (YES at step X6 in FIG. 11), when the receiving unit 12 is in operation of receiving the print data from the host computer PC3. And the receiving unit 12 suspends receiving the print data to the hard disk drive 17 (step X10), and gives the controlling unit 13 notice of completion of data receiving (step X11). Upon receipt of the notice of completion of data receiving, the controlling unit 13 sets the state table 19 accordingly (step Y27 in FIG. 12).

The receiving unit 12 gives the controlling unit 13 notice of resuming the receiving operation of the print data (step X12 in FIG. 11). Upon receipt of the notice, the controlling unit 13 searches through the records in the state table 19 (step Y2 in FIG. 12). When it is determined that RAM 13 is available (YES at step Y3), the controlling unit 13 secures an area in RAM 18 (step Y28) and sets the state table 19 (step Y29), giving the receiving unit 12 a response of a receiving-start allowance to RAM 18 (step Y30).

Upon receipt of the above response (YES at step X3 in FIG. 11), the receiving unit 12 initializes the storing size of data accumulating in RAM 18 to write received data (step X14). The receiving unit 12 writes received data into RAM 18 (YES at step X15, step X16) and renews the storing size of data accumulating in RAM 18 (step X17). When no data is received (NO at step X15), the receiving unit 12 gives the controlling unit 13 notice of completion of data receiving (step X18).

As described above, for example, the print data sent from the host computer PC3 is initially stored in the hard disk drive 17 but is halfway changed to be stored in RAM 18, and thereafter the remaining print data is stored in RAM 18.

In the second embodiment described above, when the print data previously stored in RAM 18 is read therefrom and an empty area is prepared in RAM 18 after the process has started once of storing the print data in the hard disk drive 17, the print data can be stored in the empty area of RAM 18 thereafter, which allows the RIP unit 14 to transfer the print data at a high rate.

In the second embodiment described above, the print data output from the host computer PC3 is stored in the hard disk drive 17 and RAM 18, the RIP unit 14 performs the RIP process on the data in the hard disk drive 17 in response to the notice of starting of the RIP process.

The state table 19 shown in FIG. 15 represents that the RIP process is performed on the print data sent from the personal computer PC2 registered in the present record number 1, the reading size of the accumulating data in the hard disk drive 17 is initialized (step Z9 in FIG. 14), and the print data is read from the hard disk drive 17 to be subjected to the RIP process (step Z11) while such data is left in the hard disk drive 17 (YES at step Z10). And the reading size of the accumulating data in the hard disk drive 17 is renewed (step Z12), and it is judged whether image data of one page has been completed (step Z13). When it is determined that the image data of one page has not been completed (NO at step Z13), the above processes are repeatedly performed (steps Z10 to Z13).

When it is determined that the image data of one page has been completed (YES at step Z13), the RIP unit 14 gives the transferring unit 15 notice of data transfer (step Z14). Then, the RIP unit 14 judges whether any print data is left in the hard disk drive 17 (step Z10). When it is determined that no print data is left in the hard disk drive 17 (NO at step Z10), the RIP unit 14 gives the controlling unit 13 notice of completion of the RIP process on the data in the hard disk drive 17 (step Z15).

After completing the above processes, the controlling unit 13 performs a process “C” shown in FIG. 12 (more specifically, the process “C” shown in FIG. 13). More specifically, the controlling unit 13 searched through the records in the state table 19 (step Y33 in FIG. 13) to judges whether any print data is found in the hard disk drive 17 (step Y34).

As described above, since the print data sent from the host computer PC3 is stored in the hard disk drive 17 and RAM 18, the controlling unit 13 gives the RIP unit 14 notice of proceeding with the RIP process on the data in hard disk drive 17 (step Y35). The RIP unit 14 reads the print data from the hard disk drive 17 to read the initial print data sent from the host computer PC3, and executes the RIP process on the read data in the same manner as described above. Then the RIP unit 14 outputs the processed data from the transferring unit 15 to the printer engine 16 (steps Z9 to Z14 in FIG. 14).

After performing the RIP process on the print data (NO at step Z10, step Z15), the RIP unit 14 gives the controlling unit 13 notice of the notice of completion of the RIP process (step Z15). Upon receipt of the notice of completion of the RIP process from the RIP unit 14, the controlling unit 13 judges whether the RIP unit 14 has finished performing the RIP process on the print data in the hard disk drive 17 (step Y34 in FIG. 13). When it is determined that the RIP unit 14 has finished performing the RIP process on the print data in the hard disk drive 17 (YES at step Y34), the controlling unit 13 judges whether any print data is left in RAM 18 (step Y36). In this case, since the print data sent from the host computer PC3 is stored in RAM 18, it is determined that the print data is left in RAM 18, too (YES at step Y36).

The controlling unit 13 sets the state table 19 accordingly (step Y37) and gives the RIP unit 14 notice of performing the RIP process on the print data in RAM 18 (step Y38). The RIP unit 14 performs the RIP process on the print data in RAM 18 (steps Z2 to Z7 in FIG. 14) and gives the controlling unit 13 notice of completion of the RIP process (step Z8).

In the second embodiment described above, when the RIP process is performed on the print data previously stored in RAM 18 and an empty area is produced in RAM 18 after the process has started once of storing the print data in the hard disk drive 17, the print data can be stored in such empty area RAM 18 thereafter, which allows the RIP unit 14 to execute the RIP process at a high rate, whereby the printing operation can be performed at a high speed.

Now, the third embodiment of the invention will be described.

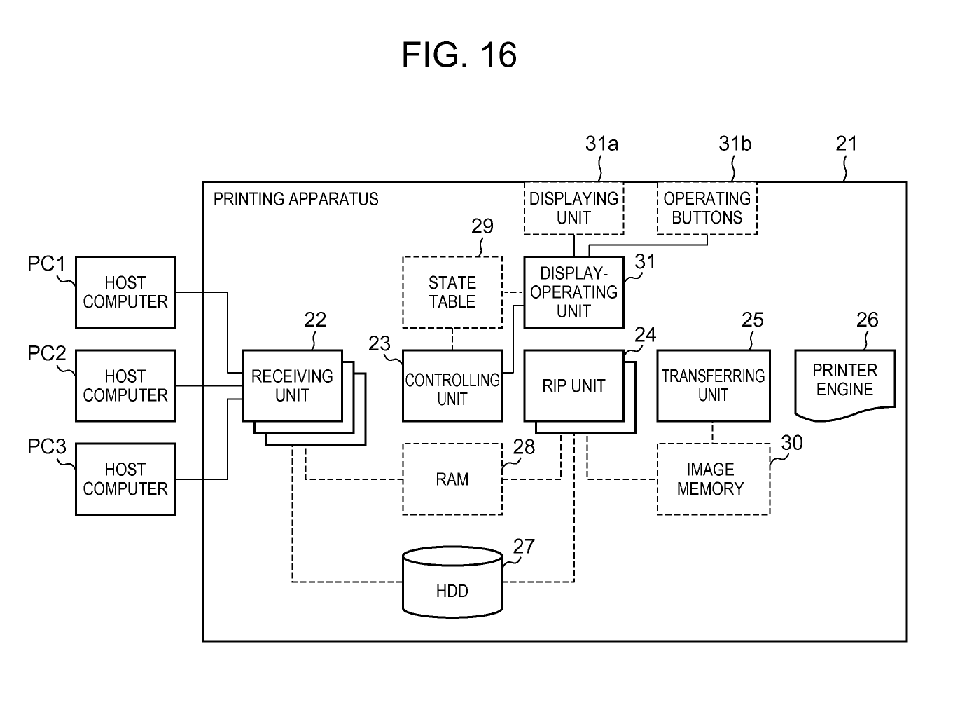

FIG. 16 is a view illustrating the system configuration of the printing apparatus according to the third embodiment of the invention. The printing apparatus 21 according to the third embodiment of the invention is connected to three host computers PC1 to PC3 via the network such as LAN. The printing apparatus 21 comprises a receiving unit 22, a controlling unit 23, RIP unit 24, a transferring unit 25, a printer engine 26, a hard disk drive 27, RAM 28, a state table 29 and an image memory 30. Further, the printing apparatus 21 has a display-operating unit 31 and the display-operating unit 31 is provided with a displaying unit 31a and operation buttons 31b.

Similarly, with use of a printer driver the host computers PC1 to PC3 convert data produced in accordance with application software into print data (PDL data) and sends the print data (PDL data) to the printing apparatus 21. When the receiving unit 22 receives the print data sent from the host computers PC1 to PC3, the printing apparatus 21 sends the receiving-start signal to the controlling unit 23. The receiving unit 22 receives the print data sent from the host computers PC1 to PC3 and sends the received data to the hard disk drive 27 or RAM 28. The receiving unit 22 is capable of simultaneously receiving the print data sent from plural host computers.

Upon receipt of the receiving-start signal from the receiving unit 22, the controlling unit 23 gives the receiving unit 22 a response of a receiving-start allowance and searches through all the records in the state table 29 to perform various controlling operations to be described later.

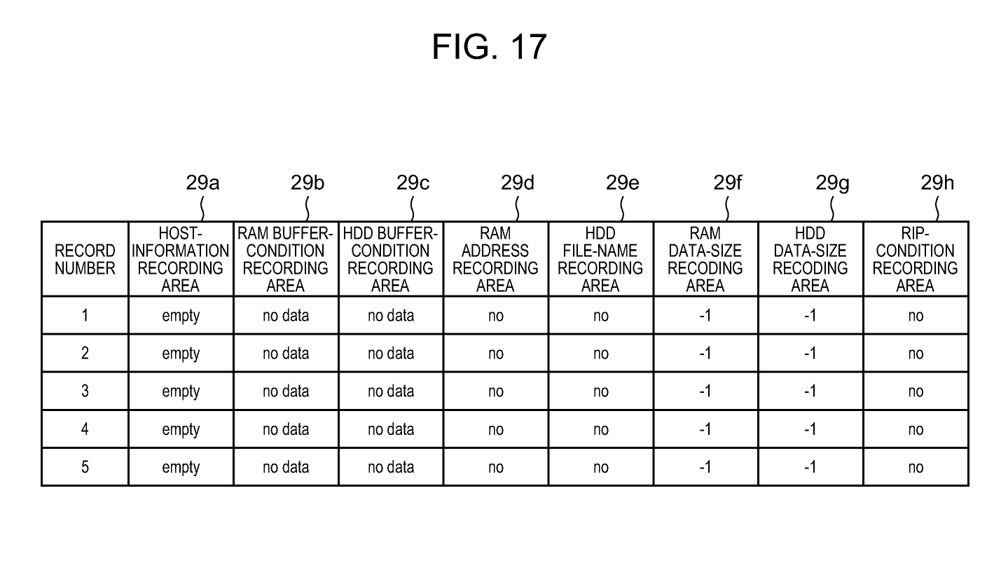

FIG. 17 is a view showing the configuration of data contained in the state table 29. In the state table 29 is registered information of the print data sent from the host computers PC1 to PC3. Similar to the state table 19 used in the second embodiment of the invention, the state table 29 used in the third embodiment has a host-information recording area 29a, a RAM buffer-condition recording area 29b, a HDD buffer-condition recording area 29c, a RAM address recording area 29d, a HDD file-name recording area 29e, a RAM data-size recording area 29f, a HDD data-size recording area 29g, and a RIP condition recording area 29h, and records various sorts of information in areas corresponding to the record numbers, respectively.

For instance, the host-information recording area 29a records information of the host computers PC1 to PC3, which have sent the print data, the RAM buffer-condition recording area 29b records information representing whether the print data is stored in RAM 28, and the HDD buffer-condition recording area 29c records information representing whether the print data is stored in the hard disk drive 27. Further, the RAM address recording area 29d records addresses of the print data stored in RAM 28.

The HDD file-name recording area 29e records file names of the print data stored in the hard disk drive 27, the RAM data-size recording area 29f records data sizes of the files stored in RAM 28, the HDD data-size recording area 29g records data sizes of the files stored in the hard disk drive 27, and the RIP condition recording area 29h records driving conditions of the RIP unit 24. For instance, while the RIP unit 24 is in operation, information of “RAM in RIP operation” and/or “HDD in RIP operation” are recorded in the RIP condition recording area 29h.

At the initial stage of the state table 29 as shown in FIG. 17, similar to the state table 19 shown in FIG. 9, all the records in the host-information recording area 29a are reset to “empty”, all the records in the RAM buffer-condition recording area 29b are reset to “no data”, all the records in the HDD buffer-condition recording area 29c are reset to “no data”, all the records in the RAM address recording area 29d are reset to “no”, all the records in the HDD file-name recording area 29e are reset to “no”, all the records in the RAM data-size recording area 29f are reset to “−1”, all the records in the HDD data-size recording area 29g are reset to “−1”, and all the records in the RIP condition recording area 29h are reset to “no”.

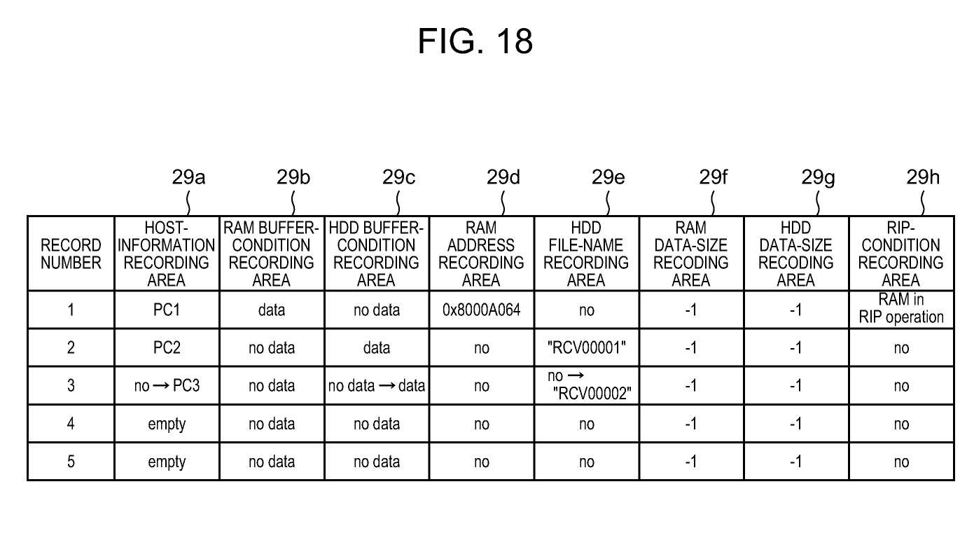

The processing operation of the printing apparatus 21 with the configuration described above will be described hereinafter. Before describing the printing operation by the printing apparatus 21, it is assumed that information shown in FIG. 18 is already registered in the state table 29. For instance, in the host-information recording area 29a of the record number 1 is recorded information of “PC1”, which represents that the print data has been sent from the host computer PC1, and in the RAM buffer-condition recording area 29b of the record number 1 is recorded information of “data”, which represents that the print data is stored in RAM 28. In the RAM address recording area 29d of the record number 1 is recorded information of “0x8000A064”, which represents that the address where the print data is stored is “0x8000A064”.

As described above, the information of the print data sent from the host computer PC1 is recorded in the state table 29 of the record number 1, and the information of “RAM in RIP operation” is stored in the RIP condition recording area 29h of the record number 1. Accordingly, it will be understood from the state table 29 that the RIP unit 24 is in operation and analyzing the print data stored in RAM 28.

In the similar manner, in the host-information recording area 29a of the record number 2 is recorded the information of “PC2”, which represents that the print data has been sent from the host computer PC2, and in the HDD buffer-condition recording area 29c of the record number 2 is recorded information of “data”, which represents that the print data is stored in the hard disk drive 27. In the HDD file-name recording area 29e of the record number 2 is recorded the information of “RCV00001”, which represents that the file name of print data is “RCV00001”.

At the time when the process starts in the third embodiment of the invention, it is assumed that the remaining records in the state table 29 are set to the initial conditions, respectively.

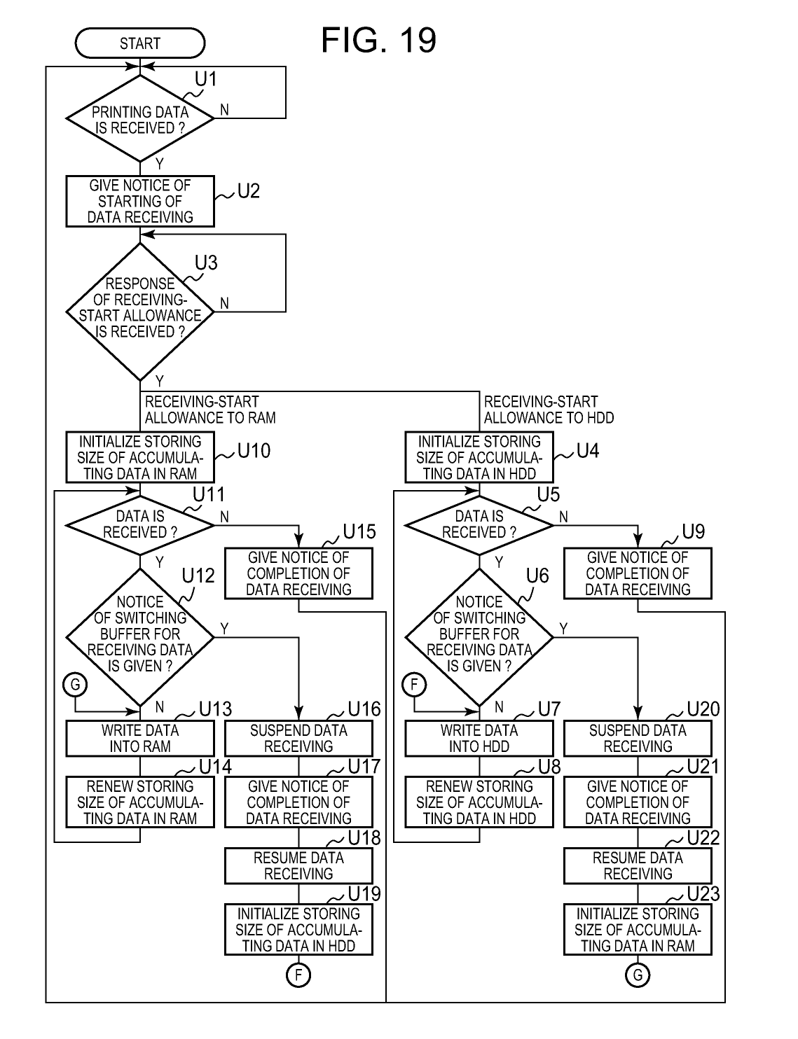

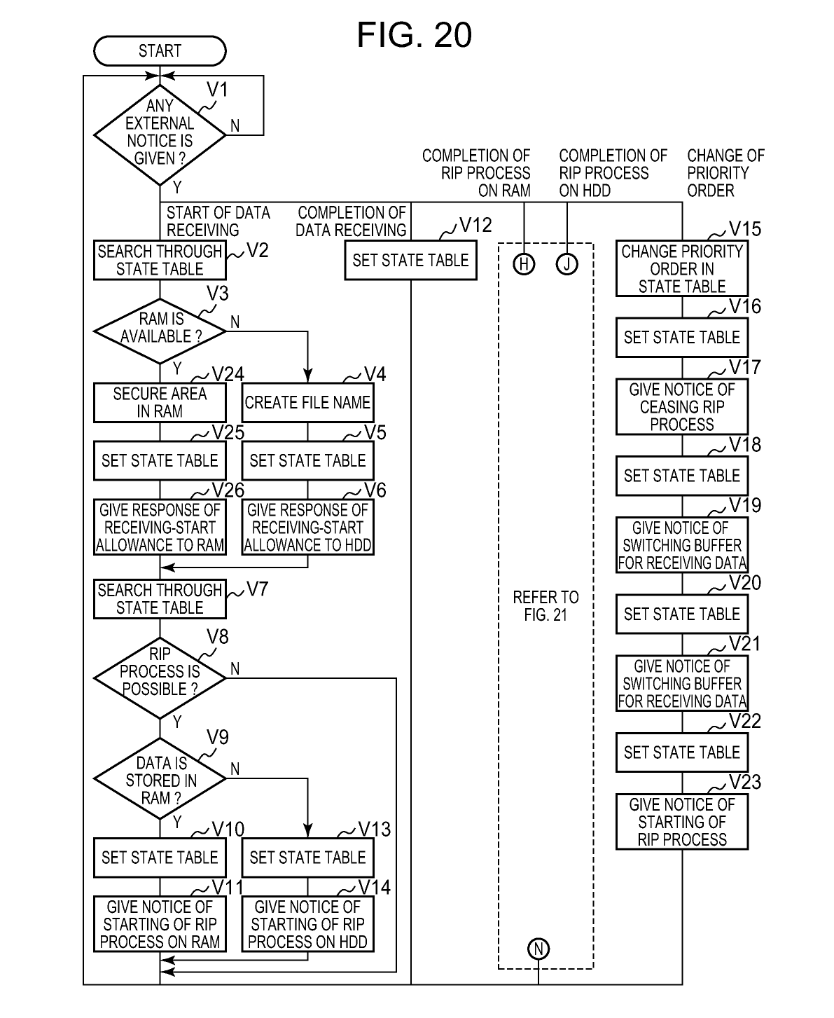

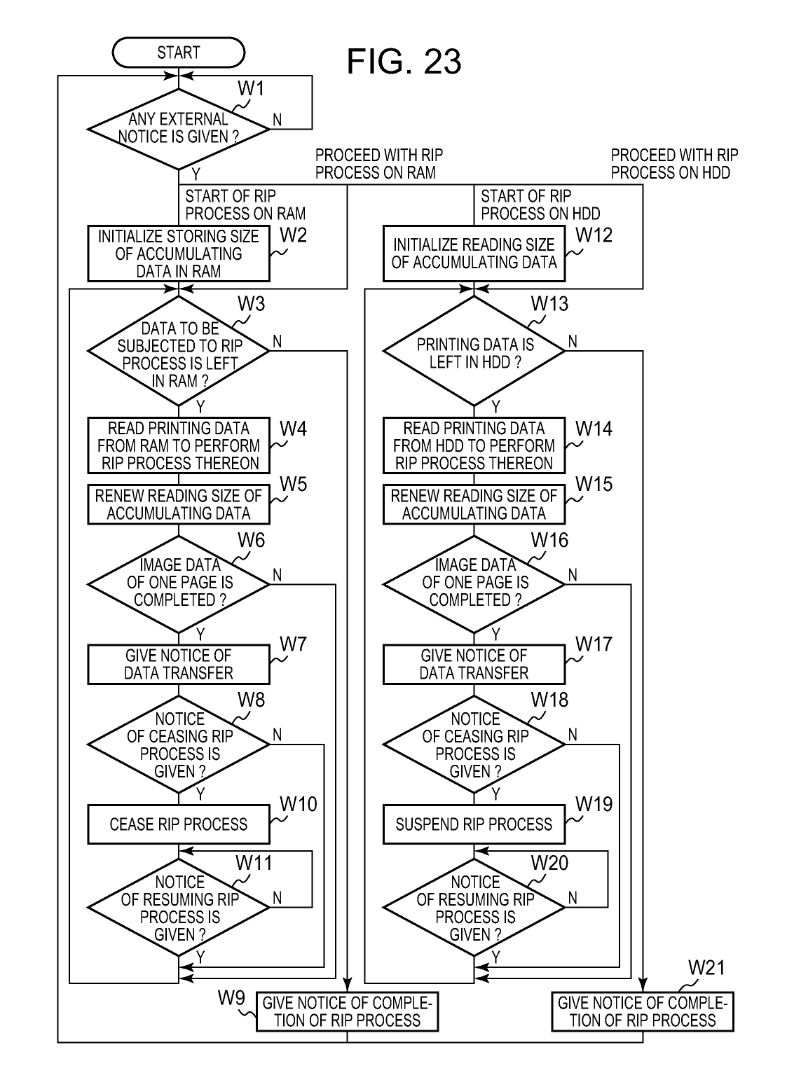

FIG. 19 is a flow chart of a processing operation performed by the receiving unit 22 in the third embodiment of the invention. FIGS. 20 to 22 are flow charts of a processing operation performed by the controlling unit 23 in the third embodiment of the invention. FIG. 23 is a flow chart of a processing operation performed by the RIP unit 24 in the third embodiment of the invention.

The receiving unit 22 judges whether the print data has been received from any of the host computers PC1 to PC3 connected to the network (step U1 in the flow chart of FIG. 19). While no print data is received (NO at step U1), the receiving unit 22 repeatedly judges at step U1 whether the print data has been received. When the print data has been received from either of the host computers PC1 to PC3 (YES at step U1), the receiving unit 22 gives the controlling unit 23 notice of starting of print data receiving (step U2), and waits for a response of a receiving-start allowance from the controlling unit 23 (step U3).

Hereinafter, the third embodiment of the invention will be described on the assumption that the print data has been already input to the receiving unit 22 from the host computers PC1 and PC2 and new print data will be input to the receiving unit 2 from the host computer PC3, as indicated in the state table 29 shown in FIG. 18.

Upon receipt of the receiving-start signal from the receiving unit 22, the controlling unit 23 judges whether any external notice has been received (step V1 in the flow chart shown in FIG. 20). In this case, the controlling unit 23 has received the receiving-start signal from the receiving unit 22 (YES at step V1), and searches through the records in the state table 29 (step V2) to judges whether RAM 28 is available (step V3). In the same manner as described above, this judgment is made by referring to the record registered in RAM buffer-condition recording area 29b of the state table 29 shown in FIG. 18.

In the state table 29 shown in FIG. 18, the information of “data” is registered in the RAM buffer-condition recording area 29b of the record number 1 and the print data sent from the host computer PC1 has been already stored in RAM 28.

Therefore, RAM 28 is in use at present and it is determined that RAM 28 is not available (NO at step V3). Then, a HDD file-name is created (step V4) and the file name is set to the corresponding area in the state table 29 (step V5). For instance, in the state table 29 shown in FIG. 18, in the host-information recording area 29a of the record number 3 is recorded the information of “PC3”, which represents that the print data has been sent from the host computer PC3, in the HDD buffer-condition recording area 29c of the record number 3 is recorded the information of “data”, which represents that the print data is stored in the hard disk drive 17, and in the HDD file-name recording area 29e of the record number 3 is recorded the information of the file name “RCV00002”. Then, the controlling unit 23 gives the receiving unit 22 a response of a receiving-start allowance to the hard disk drive 27 (step V6).

Upon receipt of the response of a receiving-start allowance from the controlling unit 23 (YES at step U3 in FIG. 19), the receiving unit 22 judges whether the response of a receiving-start allowance is to RAM 28 or to the hard disk drive 27. Since the response of a receiving-start allowance is to the hard disk drive 27, the receiving unit 22 initializes the storing size of data accumulating in the hard disk drive 27 (step U4).

The receiving unit 22 judges whether any data has been received (step U5). When it is determined that data (print data) has been received (YES at step U5), the receiving unit 22 judges whether notice of switching the buffer for receiving data has been given (step U6). In the third embodiment of the invention, the notice of switching the buffer is output, for instance, when an instruction of interruption-process is given, as will be described.

When notice of switching the buffer is not given (NO at step U6), the receiving unit 22 writes the print data into the hard disk drive 27 (step U7) and renews the storing size of data accumulating in the hard disk drive 27 (step U8). Thereafter, the receiving unit 22 repeatedly performs the above processes (steps U5, U6, U7 and U8) to write the print data into the hard disk drive 27. When no more print data is input to the receiving unit 22 (NO at step U5), the receiving unit 22 gives the controlling unit 23 notice of completion of print data receiving (step U9). Upon receipt of the notice of completion of print data receiving, the controlling unit 23 sets the state table 29 (step V12 in FIG. 20).

The above processes are performed in a period, in which notice of switching the buffer is given to the receiving unit 12, that is, in which no instruction of interruption-process is given.

Meanwhile, an input process is simultaneously performed to input the print data into RAM 28 from the host computer PC1. In the input process, upon receipt of the notice of a receiving-start allowance, the receiving unit 22 initializes the storing size of accumulating data in RAM 28 (step U10), judges whether the data is received (step U11), judges whether notice of switching the buffer for receiving data is given (step U12), and writes the print data into RAM 28 (step U13). Further, the receiving unit 22 renews the storing size of accumulating data in RAM 28 (step U14). The receiving unit 22 repeatedly performs the above processes (steps U11, U12, U13 and U14) to write the print data into RAM 28. When the input of the print data into RAM 28 has completed (NO at step U11), the receiving unit 22 gives the controlling unit 23 notice of completion of print data receiving (step U15). This process is performed when no notice of switching the buffer for receiving data is given.

The controlling unit 23 gives the receiving unit 22 a response of a receiving-start allowance (step V6 in FIG. 20), and then searches through the records in the state table 29 (step V7) to judge whether it is possible for the RIP unit 24 to execute the RIP process (step V8). The judgment is made by referring to the record in the RIP condition recording area 29h of the state table 29 shown in FIG. 18. In the state table 29 shown in FIG. 18, since the information of “RAM in RIP operation” is registered in the RIP condition recording area 29h of the record number 1 (NO at step V8), the RIP process is executed on the print data stored in RAM 28.

Meanwhile, when it is determined that the information of “RAM in RIP operation” is not registered in the RIP condition recording area 29h of the record number 1 (YES at step V8) and data is stored in RAM 28 (YES at step V9), the controlling unit 23 registers the information of “RAM in RIP operation” in the RIP condition recording area 29h of the state table 29 (step V10), and gives the RIP unit 24 notice of starting of the RIP process on the data in RAM 28 (step V11). Even when no print data is stored in RAM 28 (NO at step V9) but the print data is stored in the hard disk drive 27, the controlling unit 23 registers the information of “HDD in RIP operation” in the RIP condition recording area 29h of the state table 29 (step V13), and gives the RIP unit 24 notice of starting of the RIP process on the print data in the hard disk drive 27 (step V14).

The RIP unit 24 judges whether any external notice has been given and starts the RIP process (step W1 in the flow chart shown in FIG. 23). The RIP unit 24 initializes the reading size of the accumulating data in RAM 28 (step W2). In the state table 29 shown in FIG. 18, the information of “RAM in RIP operation” is registered, and the RIP unit 24 initializes the reading size of the accumulating data in RAM 28.

Then, the RIP unit 24 judges if there is left in RAM 28 data to be subjected to the RIP process (step W3). When it is determined that the print data is left in RAM 28 (YES at step W3), the RIP unit 24 reads the print data from RAM 28 to execute the RIP process thereon (step W4). The RIP unit 14 renews the reading size of the accumulating data (step W5), and judges whether image data of one page has been completed (step W6). When it is determined that the image data of one page has not yet been completed (NO at step W6), the RIP unit 24 repeatedly performs the above processes (steps W3 to W6).

When the image data is successively expanded on the image memory 30 and the image data of one page is completed (YES at step W6), the RIP unit 24 gives the transferring unit 25 notice of data transfer (step W7). Thereafter, the RIP unit 24 judges if notice of ceasing the RIP process has been given from RAM 28 (step W8). The notice of ceasing the RIP process is given when the instruction of interruption-process is given. When no notice of ceasing the RIP process is given (NO at step W8), the RIP unit 24 keeps performing the RIP process. When no print data is left in RAM 28 (NO at step W3), the RIP unit 24 gives the controlling unit 23 notice of completion of the RIP process (step W9).

Meanwhile, plural pieces of information of the print data registered in the state table 29 shown in FIG. 18 are displayed on the displaying unit 31a of the display-operating unit 31, wherein the plural pieces of information correspond to the record numbers, respectively. A user of the printing apparatus confirms the plural pieces of information displayed on the displaying unit 31a and operates the operation buttons 31b to give the instruction of interruption for printing operation. An operation signal is input to the controlling unit 23 from the display-operating unit 31 in response to the operation of the operation buttons 31b by the user.

For instance, in the case where the instruction of interruption is given to perform a printing operation of printing first the print data corresponding to the information registered in the record number 3, the controlling unit 23 executes a process for changing a priority order in the state table (YES at step V1 and step V15 in FIG. 20). Then, the controlling unit 23 sets the state table 29 (step V16) to rearrange the records in a new order in the state table 29.

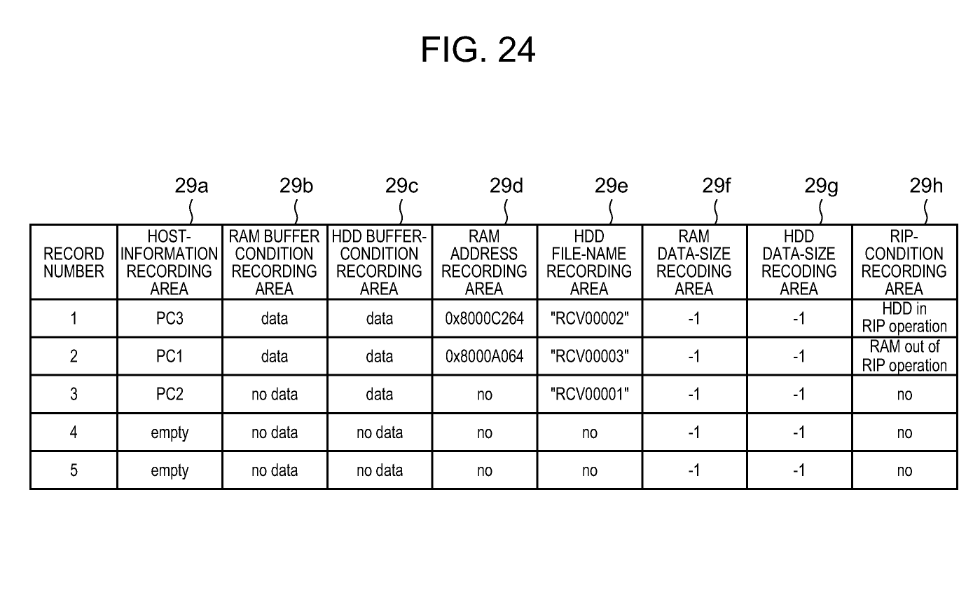

FIG. 24 is a view showing the state table 29 used to explain the process in the third embodiment of the invention. In the case where the instruction of interruption for printing operation is given to print and output first the print data of the information registered in the record number 3, the records (information) recorded in the areas of the record number 3 are moved up to the areas of the record number 1, the records (information) recorded in the areas of the record number 1 are moved down to the areas of the record number 2, and the records (information) recorded in the areas of the record number 2 are moved down to the areas of the record number 3.

Then, the controlling unit 23 gives the RIP unit 24 notice of ceasing the RIP process (step V17 in FIG. 20) and sets the state table 29 (step V18). In this table setting process (step V18), information of “RAM out of RIP operation” is set in the RIP condition recording area 29h of the record number 2 as shown in FIG. 24.

Upon receipt of the notice of ceasing the RIP process from the controlling unit 23 (YES at step W8 in FIG. 23), the RIP unit 24 ceases the RIP process (step W10), and waits for notice of resuming the RIP process from the controlling unit 23 (step W11).

Then, the controlling unit 23 gives the receiving unit 22 notice of switching the buffer for receiving data (step V19 in FIG. 20). In other words, the controlling unit 23 gives the receiving unit 22 notice of switching the buffer for receiving the print data of the host computer PC1 stored in RAM 28 (steps U10 to U14 in FIG. 19), and sets the state table 29 (step V20 in FIG. 20).

Upon receipt of the notice of switching the buffer for receiving data (YES at step U12 in FIG. 19), the receiving unit 22 suspends receiving the print data (step U16) and gives the controlling unit 23 notice of completion of data receiving (step U17). The receiving unit 22 resumes receiving the print data (step U18) and initializes the storing size of accumulating data in the hard disk drive 27 (step U19).

Upon receipt of a notice of resuming data-receiving from the receiving unit 22 (YES at step V1 in FIG. 20), the controlling unit 23 searches through the records in the state table 29 (step V2) to judge whether RAM 28 is available (step V3). Since the print data of the host computer PC1 stored in RAM 28 is stored in the hard disk drive 27 (NO at step V3), a HDD file-name is created (step V4) and the file name is set to the corresponding area in the state table 29 (step V5). For instance, in the case of the state table 29 shown in FIG. 24, the information of a file name “RCV00003” is recorded in the HDD file-name recording area 29e of the record number 2. Then, the controlling unit 23 gives the receiving unit 22 a response of a receiving-start allowance to the hard disk drive 27 (step V6).

Thereafter, the print data sent from the host computer PC1 is stored with the file name of “RCV00003” in the hard disk drive 27.

Further, the controlling unit 23 gives the receiving unit 22 notice of switching the buffer for receiving the print data sent from the host computer PC3 (step V21). In other words, the controlling unit 23 gives the receiving unit 22 notice of switching the buffer for receiving the print data, which are stored in the hard disk drive 27 in the processes of steps U4 to U8 in FIG. 19. And the controlling unit 23 sets the state table 29 (step V22) and gives the RIP unit 24 notice of starting of the RIP process (step V23).

Upon receipt of the notice of switching the buffer from the controlling unit 23 (YES at step U6 in FIG. 19), the receiving unit 22 suspends receiving the print data (step U20), and gives the controlling unit 23 notice of completion of data receiving (step U22). The receiving unit 22 resumes print data receiving (step U22), and initializes the storing size of accumulating data in RAM 28 (step U23).

Upon receipt of the notice of resuming print data receiving from the receiving unit 22 (YES at step V1 in FIG. 20), the controlling unit 23 searches through the records in the state table 29 (step V2) to judge whether RAM 28 is available (step V3). When it is determined that RAM 28 is available (YES at step V3), the controlling unit 23 secures an area in RAM 28 (step V24), sets the state table 29 (step V25) and gives the receiving unit 22 a response of a receiving-start allowance to RAM 28 (step V26).

Thereafter, the receiving unit 22 stores in RAM 28 the print data sent from the host computer PC3 (steps U11 to U14), and gives the controlling unit 23 notice of completion of data receiving when no print data is input from the host computer PC3 (step U15).

In the above processes, the print data sent, for example, from the host computer PC3 and stored in the hard disk drive 27 is stored in RAM 28 after the instruction of interruption-process is given, and the print data sent, for example, from the host computer PC1 and stored in RAM 28 is stored in the hard disk drive 27 after the instruction of interruption-process is given. Therefore, even if the instruction of interruption-process is given, the medium where the print data is to be stored is quickly switched and the print data can be stored in the hard disk drive 27 or in RAM 28.

In this case, the RIP process is in a suspended state, which is to be executed on the data which are stored in RAM 28 before the instruction of interruption-process has been given, and the RIP unit 24 executes the RIP process first on data, to which the instruction of interruption-process is given, to print and output said data, first.

Thereafter, the RIP unit 24 performs the RIP process first on the print data sent from the host computer PC3, to which the instruction of interruption-process is given, and then starts performing the RIP process on the data in the hard disk drive 27 in accordance with the instruction of starting the RIP process given by the controlling unit 23 (step V23).

The RIP unit 24 initializes the reading size of accumulating data (step W12 in FIG. 23) to read the print data of the host computer PC3 stored in the hard disk drive 27. While the data to be subjected to the RIP process is left in the hard disk drive 27, the RIP unit 24 reads the print data from the hard disk drive 27 and executes the RIP process thereon (step W14). The RIP unit 24 renews the reading size of accumulating data (step W15), and judges whether image data of one page has been completed (step W16). When image data of one page has not been completed (NO at step W16), the RIP unit 24 repeatedly performs the above processes (steps W13 to W16).

When the image data of one page has been completed (YES at step W16), the RIP unit 24 gives the transferring unit 25 notice of data transfer (W17). Thereafter, the RIP unit 24 repeatedly performs the above process (step W13 to W18) until the notice is received of ceasing the RIP process to be performed on the print data sent from the hard disk drive 27. Further, the RIP unit 24 judges whether there is left the print data in the hard disk drive 27 (step W13). When it is determined that no print data is left in the hard disk drive 27 (NO at step W13), the RIP unit 24 gives the controlling unit 23 notice of completion of the RIP process to be performed on the print data in the hard disk drive 27 (step W21).

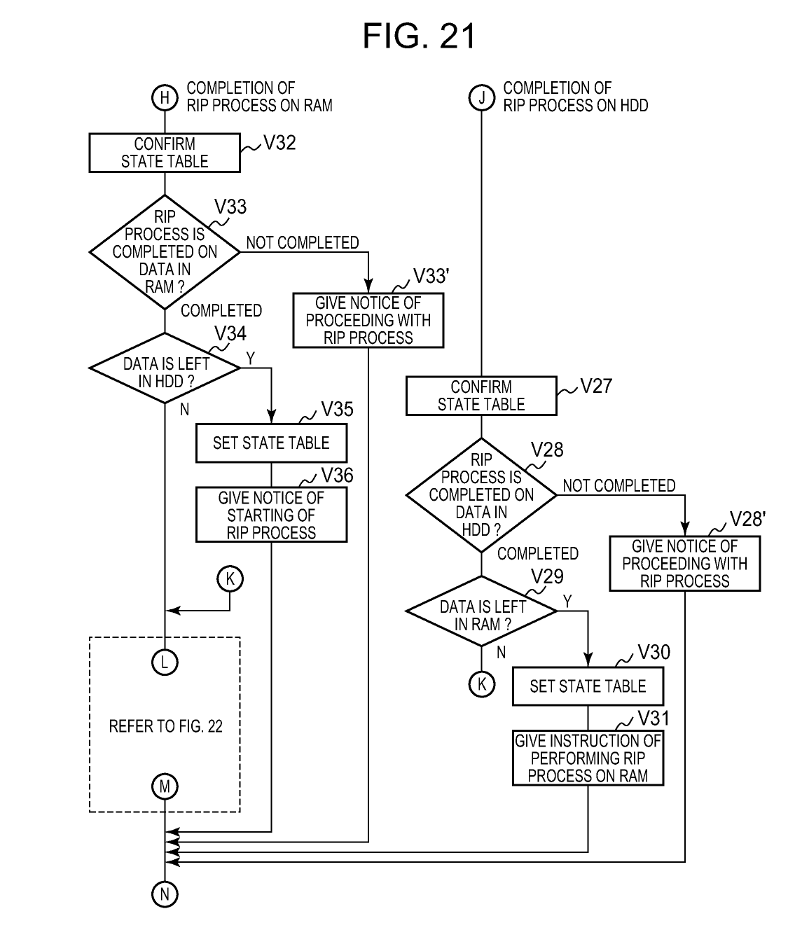

Upon receipt of the notice of completion of the RIP process from the RIP unit 24, the controlling unit 23 performs a process “J” in FIG. 20 (more specifically, the controlling unit 23 performs the process “J” shown in FIG. 21). The controlling unit 23 confirms the records in the state table 29 (step V27) to judge whether the RIP process has been completed on the print data in the hard disk drive 27 (step V28). When it is determined that the RIP process has been completed (completed at step V28), the controlling unit 23 judges whether there is left any print data in RAM 28 (step V29). In this example, since the print data sent from the host computer PC3 is stored in the hard disk drive 27 and the buffer for receiving data is switched to store the print data in RAM 28, the print data is left in RAM 28 (YES at step V29). In this case, in consideration of the print data left in the hard disk drive 27 (not completed at step V28), the controlling unit 23 gives the RIP unit 24 notice of proceeding with the RIP process (step V28′).

The controlling unit 23 sets the state table 29 (step V30), and gives the RIP unit 24 the instruction of performing the RIP process on the print data in RAM 28 (step V31). The RIP unit 24 executes the RIP process on the print data of the host computer PC3 left in RAM 28 (steps W2 to W9 in FIG. 23), and gives the controlling unit 23 notice of completion of the RIP process when the RIP process on the data in RAM 28 has been completed (step W9). In the above processes, upon receipt of the instruction of interruption-process, the RIP unit 24 executes the RIP process on the print data sent from the host computer PC3 and completes the RIP process.

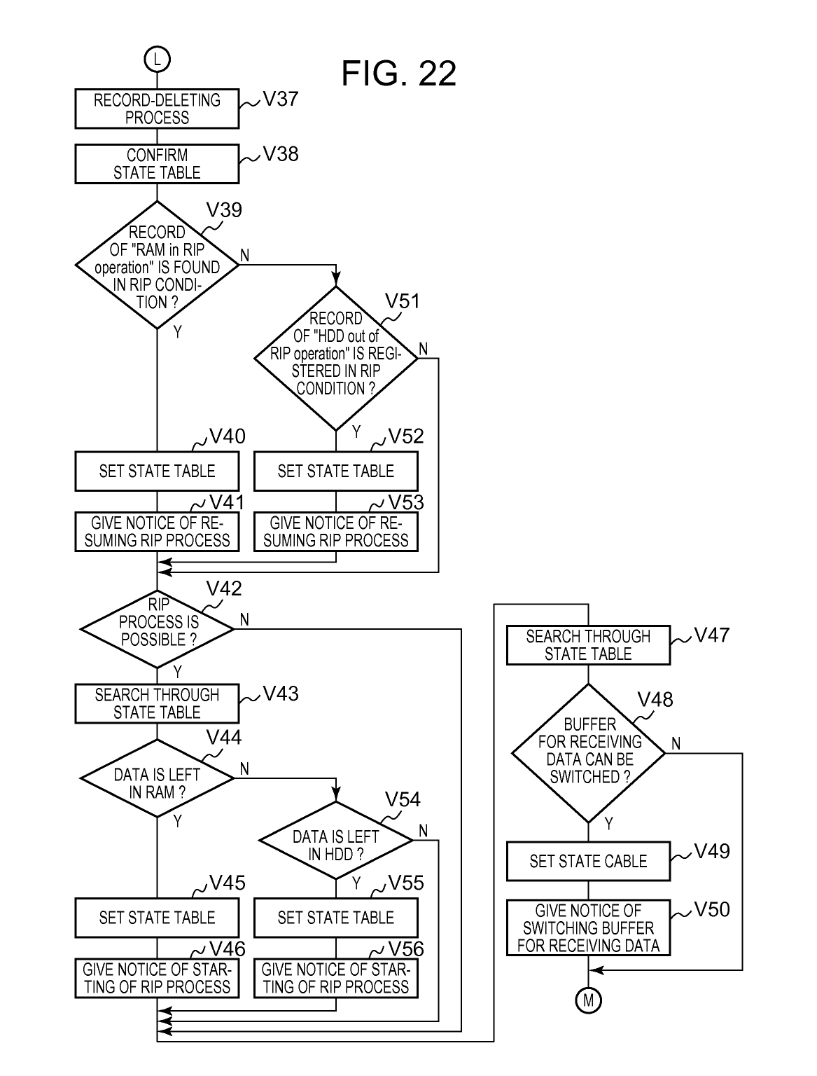

When the RIP process has been completed by the RIP unit 24, the controlling unit 23 advances to a process “H” (shown in FIGS. 20 and 21. The controlling unit 23 confirms the records in the state table 29 (step V32) to judge whether the RIP process has been completed on the print data in RAM 28 (step V33). When it is determined that the RIP process has been completed (completed at step V33), the controlling unit 23 judge whether any print data is left in the hard disk drive 27 (step V34). In this example, since the print data sent from the host computer PC1 is left in RAM 28 as indicated in the state table 29 of the record number 1, it is determined NO at step V34 and the controlling unit 23 advances to a process “L” shown in FIGS. 21 and 22. Meanwhile, when the print data is left in the hard disk drive 27 (YES at step V34), the controlling unit 23 sets the state table 29 (step V35) and gives the RIP unit 24 notice of starting of the RIP process (step V36).

The controlling unit 23 deletes the information registered in the record number 1 from the state table 29 (step V37 in FIG. 22), wherein the information relates to the print data sent from the host computer PC3 and has been processed in accordance with the instruction of interruption-process. Then, the controlling unit 23 confirms the records in the state table 29 (step V38) to judge whether a record indicating “RAM out of RIP operation” is found (step V39). In the state table 29 shown in FIG. 24, a record of “RAM out of RIP operation” is recorded in the RIP condition recording area 29h of the record number 2 (YES at step V39). The controlling unit 23 sets the state table 29 (step V40) and gives the RIP unit 24 notice of resuming the RIP process (step V41).

Then, the controlling unit 23 judges whether the RIP process is possible (step V42). When the controlling unit 23 searches through the records in the state table 29 (step V43), it is determined that the RIP process is possible, because the information of the record number 1, concerning the print data sent from the host computer PC1 has been already deleted, as described above. Therefore, confirming that the print data is left in RAM 28 (YES at step V44), the controlling unit 23 sets the state table 29 (step V45). Then, the controlling unit 23 gives the RIP unit 24 notice of starting of the RIP process to be executed on the print data of the host computer PC1 left in RAM 28 (step V46).

Upon receipt of the notice of resuming the RIP process (YES at step W11 in FIG. 23), the RIP unit 24 resumes performing the RIP process on the print data sent from the host computer PC1 (steps W3 to W8). Completing the RIP process (YES at step W3), the RIP unit 24 gives the controlling unit 23 notice of completion of the RIP process on the data in RAM 28 (step W9).

Meanwhile, the controlling unit 23 searches through the records in the state table 29 (step V47 in FIG. 22) to judge whether it is possible to switch the buffer for receiving data (step V48). For instance, when the instruction of interruption-process is given (YES at step V48), the controlling unit 4 sets the state table 29 (step V49) and gives the receiving unit 22 notice of switching the buffer for receiving data (step V50).

In the third embodiment described above, when the instruction of interruption-process is given while the RIP unit 24 is executing the RIP process on the print data of the host computer PC1 stored in RAM 28 (YES at step W8 in FIG. 23), the RIP unit 24 suspends the RIP process once as described above (step W10) to execute the interruption process first. However, when the instruction of interruption-process is given while the RIP unit 24 is performing the RIP process on the print data stored in the hard disk drive 27 (YES at step W18), the RIP unit 24 suspends the RIP process once (step W19) and executes a printing process first on the print data of the record, to which the instruction of interruption-process is given. Then, the controlling unit 23 performs the following processes.

More specifically, the controlling unit 23 determines that a record of “HDD out of RIP operation” is registered in the state table 29 (step V51 in FIG. 22), sets the state table 29 (step V52), and gives the RIP unit 24 notice of resuming the RIP process (step V53). Then, the controlling unit 23 judges whether the RIP process is possible or not (step V42). When the RIP process is determined possible (YES at step V42), the controlling unit 23 searches through the records in the stated table 29 (step V43). Since the print data is left in the hard disk drive 29 (YES at step V54), the controlling unit 23 sets the state table 29 (step V55), and gives the RIP unit 24 notice of resuming the RIP process to be performed on the print data in the hard disk drive 29 (step V56).

Upon receipt of the notice of resuming the RIP process (YES at step W20 in FIG. 23), the RIP unit 24 resumes performing the RIP process on the print data left in the hard disk drive 29 (steps W13 to W19). When the RIP process has been completed (YES at step W13), the RIP unit 24 gives the controlling unit 23 notice of completion of the RIP process on the data in RAM 28 (step W21).

In the printing apparatus described above, even if the instruction of interruption-process should be given during the process of receiving the print data into the hard disk drive 27 or RAM 28, the records in state table 29 are promptly arranged so as to response the interruption process applied to the print data, whereby the printing process is executed first on the print data to which the interruption process has been applied. Thereafter, the print data, on which the RIP process was suspended, is subjected to the printing process, whereby the printing process can be performed promptly and effectively in response to the instruction of interruption-process.

As RAMs 8, 18 and 28 used in the first to third embodiment of the invention can be used a ring buffer of a fixed size, but for instance, other type of buffer such as a double buffer can be employed as RAM in place of the ring buffer.

In the first embodiment to third embodiment of the invention, RAMs 8, 18 and 28, which have small memory capacities and allow high speed data access, and the hard disk drives 7, 17 and 27, which have large memory capacities and allow low speed data access are used as the buffers for receiving data. But any devices can be used as the buffer for receiving data in the printing apparatus according to the embodiments of the invention, as far as they are used in combination of a receiving buffer, which has a small memory capacity and allows relatively high speed access and a receiving buffer, which has a large memory capacity and allows relatively low speed access.

In the first embodiment to third embodiment of the invention, RAMs 8, 18 and 28 each are described as a single element, but plural elements can be used as each of RAMs 8, 18 and 28 depending on available RAM size.

In the state tables 9, 19 and 29, the records are controlled in record-number order but can be controlled in priority order, which is decided separately. Further, the number of record numbers is fixed as “5” in the state tables 9, 19 and 29, but the larger number of record numbers can be used.

In the third embodiment of the invention, the display-operating unit 31 can be arranged to watch the state table 29 at regular intervals. Further another arrangement can be made in which, when the state table 23 is changed, the controlling unit 23 gives the display-operating unit 31 notice to that effect, and upon receipt of the notice, the display-operating unit 31 displays the changed state table.

In the third embodiment of the invention, an amendment can be made, in which, in addition to the information (host information) registered in host-information recording area 29a, a name of the user and dates, on which the printing process is executed are contained in the state table 29 and displayed on the display-operating unit 31.

In the third embodiment of the invention, the operation buttons 31b is operated to change the priority order of printing the host information displayed on the display-operating unit 31. But a device of a touch panel system and/or an input device of a voice-input system can be used in place of the operation buttons 31b.

In the third embodiment of the invention, the priority order of printing the records corresponding to the host information designated by operation of the operation buttons 31b is changed very first, but the priority order of other items can be changed.

The processes performed in accordance with the flowcharts shown in the embodiments of the invention can be written as a computer program into a recording medium such as a magnetic disk, optical disk, and semi-conductor memory, and such recording medium with the computer program written therein can be mounted on various apparatuses and also such computer program can be transferred to various apparatuses via a communication medium. When such computer program is run by a computer in the apparatus on which such recording medium is mounted, substantially the same effects can be realized as those in the embodiments of the present invention. The computer is not limited to that built in the embodiments of the invention, but any computer can be used, which is able to read the above described computer program stored in the recording medium and is provided with CPU that works in accordance with the read computer program.

Although specific embodiments of the present invention have been illustrated in the accompanying drawings and described in the foregoing detailed description, it will be understood that the invention is not limited to the particular embodiments described herein, but numerous rearrangements, modifications, and substitutions can be made to the embodiments described herein without departing from the scope of the invention. The following claims are intended to encompass all such modifications.

What is claimed is:

1. A printing apparatus for printing on a print medium print data received from plural host apparatuses, the printing apparatus comprising:
a first memory unit which stores the print data received from one of the plural host apparatuses;
a second memory unit of a data access speed lower than the first memory unit, which stores the print data received from another one of the plural host apparatuses when the first memory unit is in use for storing the print data received previously;
a receiving unit which receives the print data in parallel from the plural host apparatuses;
a judging unit which judges whether the first memory unit is in use; and
a storing-process controlling unit which starts a first storing process for storing first received print data in the first memory unit, when the judging unit determines that the first memory unit is not in use, and which starts a second storing process for storing second received print data in the second memory unit, when the first storing process is in process and the judging unit determines that the first memory unit is in use.

2. A printing apparatus for printing on a print medium print data received from plural host apparatuses, the printing apparatus comprising:
a first memory unit which stores the print data received from one of the plural host apparatuses;
a second memory unit of a data access speed lower than the first memory unit, which stores the print data received from another one of the plural host apparatuses when the first memory unit is in use for storing the print data received previously;
a receiving unit which receives the print data in parallel from the plural host apparatuses;
a judging unit which judges whether the first memory unit is in use;
a storing-process controlling unit which starts a first storing process for storing first received print data in the first memory unit, when the judging unit determines that the first memory unit is not in use, and which starts a second storing process for storing second received print data in the second memory unit, when the first storing process is in process and the judging unit determines that the first memory unit is in use; and
a memory changing unit which changes a memory area for storing print data from the second memory unit to the first memory unit, when the judging unit has determined that the first memory unit is freed while the print data is being stored in the second memory unit.

3. A printing apparatus for printing on a print medium print data received from plural host apparatuses, the printing apparatus comprising:
a first memory unit which stores the print data received from one of the plural host apparatuses;
a second memory unit of a data access speed lower than the first memory unit, which stores the print data received from another one of the plural host apparatuses when the first memory unit is in use for storing the print data received previously;
a receiving unit which receives the print data in parallel from the plural host apparatuses;
a judging unit which judges whether the first memory unit is in use;
a storing-process controlling unit which starts a first storing process for storing first received print data in the first memory unit, when the judging unit determines that the first memory unit is not in use, and which starts a second storing process for storing second received print data in the second memory unit, when the first storing process is in process and the judging unit determines that the first memory unit is in use;
a processing order determining unit which determines a processing order of the received print data;
a memory determining unit which determines a memory area for storing print data, based on the decision made by the judging unit of whether the first memory unit is in use and the decision made by the processing order determining unit; and
a memory changing unit which changes a memory area for storing print data from the second memory unit to the first memory unit, when the memory determining unit has determined to change the memory while the print data is being stored in the second memory unit, and which changes the memory area from the first memory unit to the second memory unit, when the memory determining unit has determined to change the memory while the print data is being stored in the first memory unit.

4. The printing apparatus according to claim 3, wherein when an instruction operation of interruption occurs, the memory changing unit changes the memory for storing the print data.

5. The printing apparatus according to one of claims 1, 2, 3 and 4, wherein the first memory unit comprises a random access memory.

6. The printing apparatus according to one of claims 1, 2, 3 and 4, wherein the second memory unit comprises a hard disk memory.

7. A printing method in a printing apparatus for printing on a print medium print data received from plural host apparatuses, wherein the printing apparatus has a first memory unit for storing the print data received from one of the plural host apparatuses and a second memory unit of a data access speed lower than the first memory unit, which stores the print data received from another one of the plural host apparatuses when the first memory unit is in use for storing the print data received previously, the printing method comprising the steps of:
receiving the print data in parallel from the plural host apparatuses;
judging whether the first memory unit is in use; and
starting a first storing process for storing first received print data in the first memory unit, when it is determined that the first memory unit is not in use, and starting a second storing process for storing second received print data in the second memory unit, when the first storing process is in process and it is determined that the first memory unit is in use.

8. A printing method in a printing apparatus for printing on a print medium print data received from plural host apparatuses, wherein the printing apparatus has a first memory unit for storing the print data received from one of the plural host apparatuses and a second memory unit of a data access speed lower than the first memory unit, which stores the print data received from another one of the plural host apparatuses when the first memory unit is in use for storing the data received previously, the printing method comprising the steps of:
receiving print data in parallel from the plural host apparatuses;
judging whether the first memory unit is in use;
starting a first storing process for storing first received print data in the first memory unit, when it is determined that the first memory unit is not in use, and starting a second storing process for storing second received print data in the second memory unit, when the first storing process is in process and it is determined that the first memory unit is in use; and
changing a memory area from the second memory unit to the first memory unit, when it has been determined that the first memory unit is freed while the print data is being stored in the second memory unit.

9. A printing method in a printing apparatus for printing on a print medium print data received from plural host apparatuses, wherein the printing apparatus has a first memory unit for storing the print data received from one of the host apparatuses and a second memory unit of a data access speed lower than the first memory unit, which stores the print data received from another one of the plural host apparatuses when the first memory unit is in use for storing the print data received previously, the printing method comprising the steps of:
receiving print data in parallel from the plural host apparatuses;
storing the received print data in the first memory unit;
storing the received print data in the second memory unit;
judging whether the first memory unit is in use;
starting a first storing process for storing first received print data in the first memory unit, when it is determined that the first memory unit is not in use, and starting a second storing process for storing second received print data in the second memory unit, when the first storing process is in process and it is determined that the first memory unit is in use;
determining a processing order of the received print data;
determining a memory area for storing print data, based on the decision of whether the first memory unit is in use and the decision of the processing order of the received print data; and
changing the memory area for storing print data from the second memory unit to the first memory unit, when it has been determined to change the memory while the print data is being stored in the second memory unit, and changing the memory area for storing print data from the first memory unit to the second memory unit, when it has been determined to change the memory while the print data is being stored in the first memory unit.

10. The printing method according to claim 9, wherein when an instruction operation of interruption occurs, it is determined to change the memory for storing the print data.

11. The printing method according to one of claims 7, 8, 9 and 10, wherein the first memory unit comprises a random access memory.

12. The printing method according to one of claims 7, 8, 9 and 10, wherein the second memory unit comprises a hard disk memory.

13. A computer readable recording medium mounted on a printing apparatus for printing on a print medium print data received from plural host apparatuses, wherein the printing apparatus is provided with a computer, a first memory unit for storing the print data received from one of the plural host apparatuses and a second memory unit of a data access speed lower than the first memory unit, which stores the print data received from another one of the plural host apparatuses when the first memory unit is in use for storing the print data received previously, the recording medium having recorded thereon a computer program when executed to make the computer implement a method comprising the steps of:
receiving print data in parallel from the plural host apparatuses;
judging whether the first memory unit is not in use; and
starting a first storing process for storing first received print data in the first memory unit, when it is determined that the first memory unit is not in use, and starting a second storing process for storing second received print data in the second memory unit, when the first storing process is in process and it is determined that the first memory unit is in use.

14. A computer readable recording medium mounted on a printing apparatus for printing on a print medium print data received from plural host apparatuses, wherein the printing apparatus is provided with a computer, a first memory unit for storing the print data received from one of the plural host apparatuses and a second memory unit of a data access speed lower than the first memory unit, which stores the print data received from another one of the plural host apparatuses when the first memory unit is in use for storing the print data received previously, the recording medium having recorded thereon a computer program when executed to make the computer implement a method comprising the steps of:
receiving print data in parallel from the plural host apparatuses;
judging whether the first memory unit is in use;
starting a first storing process for storing first received print data in the first memory unit, when it is determined that the first memory unit is not in use, and starting a second storing process for storing second received print data in the second memory unit, when the first storing process is in process and it is determined that the first memory unit is in use; and
changing a memory area for storing print data from the second memory unit to the first memory unit, when it has been determined that the first memory unit is freed while the print data is being stored in the second memory unit.

15. A computer readable recording medium mounted on a printing apparatus for printing on a print medium print data received from plural host apparatuses, wherein the printing apparatus is provided with a computer, a first memory unit for storing the print data received from one of the plural host apparatuses, and a second memory unit of a data access speed lower than the first memory unit, which stores the print data received from another one of the plural host apparatuses when the first memory unit is in use for storing the print data received previously, the recording medium having recorded thereon a computer program when executed to make the computer implement a method comprising the steps of:
receiving print data in parallel from the plural host apparatuses;
storing the received print data in the first memory unit;
storing the received print data in the second memory unit;
judging whether the first memory unit is in use;
starting a first storing process for storing first received print data in the first memory unit, when it is determined that the first memory unit is not in use, and starting a second storing process for storing second received print data in the second memory unit, when the first storing process is in process and it is determined that the first memory unit is in use;
determining a processing order of the received print data;
determining a memory area for storing print data, based on the decision of whether the first memory unit is in use and the decision of the processing order of the received print data; and
changing the memory area for storing print data from the second memory unit to the first memory unit, when it has been determined to change the memory while the print data is being stored in the second memory unit, and changing the memory area for storing print data from the first memory unit to the second memory unit, when it has been determined to change the memory while the print data is being stored in the first memory unit.

16. The computer readable recording medium according to claim 15, wherein, when an instruction operation of interruption occurs, it is determined to change the memory for storing the print data.

17. The computer readable recording medium according to one of claims 13, 14, 15 and 16, wherein the first memory unit comprises a random access memory.

18. The computer readable recording medium according to one of claims 13, 14, 15 and 16, wherein the second memory unit comprises a hard disk memory.
